(19) United States
(12) Patent Application Publication
(10) Pub. No.: US 2018/0272316 A1
(43) Pub. Date: Sep. 27, 2018

(54) Porous Ceramic Particles and Method of Forming Porous Ceramic Particles

(71) Applicant: Saint-Gobain Ceramics & Plastics, Inc., Worcester, MA (US)

(72) Inventors: Jonathan W. FOISE, Hudson, OH (US); Samuel M. KOCH, Broadview Heights, OH (US); Michael K. Francis, Hudson, OH (US)

(21) Appl. No.: 15/915,440

(22) Filed: Mar. 8, 2018

Related U.S. Application Data
(60) Provisional application No. 62/470,929, filed on Mar. 14, 2017.

(51) Int. Cl. B01J 21/04; B01J 21/08; B01J 21/06; B01J 23/10; B01J 35/02; B01J 35/10; B01J 37/00; B01J 37/08; B01J 37/02

(52) U.S. Cl. CPC B01J 21/04; B01J 21/08; B01J 21/066; B01J 23/10; B01J 35/023; B01J 37/0221; B01J 35/1042; B01J 35/1047; B01J 37/0045; B01J 37/08; B01J 35/1038

(57) ABSTRACT

A porous ceramic particle may have a particle size of at least about 200 microns and not greater than about 4000 microns. The porous ceramic particle may further have a particular cross-section that may include a core region and a layered region overlying the core region. The layered region may include overlapping layered sections surrounding the core region. The core region may include a core region composition and a first layered section may include a first layered section composition. The first layered section composition may be different than the core region composition.

### CROSS-REFERENCE TO RELATED APPLICATION

This application claims the benefit of U.S. Provisional Application No. 62/470,929 filed Mar. 14, 2017.

### FIELD OF THE DISCLOSURE

The present disclosure relates to porous ceramic particles and a method of forming a plurality of porous ceramic particles. In particular, the disclosure relates to the use of a spray fluidization forming process in batch mode for forming porous ceramic particles.

### BACKGROUND

Porous ceramic particles may be used in a wide variety of applications and in particular are uniquely suited to serve, for example, in the catalytic field as a catalyst carrier or component of a catalyst carrier. Porous ceramic particles used in the catalytic field need to possess, for example, a combination of at least a minimum surface area on which a catalytic component may be deposited, high water absorption and high crush strength. Achieving a minimum surface area and high water absorption may be, at least partially, accomplished through incorporating a minimum amount of porosity in the ceramic particles used as the catalyst carrier or as the component of the catalyst carrier. However, an increase in the porosity of the ceramic particles may alter other properties, such as, the crush strength of the catalyst carrier or the component of the catalyst carrier. Conversely, high crush strength may require lower porosity, which then reduces surface area and water absorption of the catalyst carrier or component of the catalyst carrier. Therefore, balancing of these properties in the porous ceramic particles, particularly when the particles are used in the catalytic field, is integral to the performance of the component. Once a balance of the necessary properties in the porous ceramic particles is achieved, uniform production of the particles is required in order to guarantee uniform performance of the component. Porous ceramic particles used as catalyst carriers or as components of catalyst carriers should therefore have a uniform degree of porosity, be of a uniform average particle size and have a uniform shape. Accordingly, the industry continues to demand improved porous ceramic particles having various desired qualities, such as, a particular porosity and improved methods for uniformly forming these porous ceramic particles.

### SUMMARY

According to one aspect of the invention described herein, a porous ceramic particle may have a particle size of at least about 200 microns and not greater than about 4000 microns. The porous ceramic particle may further have a particular cross-section that may include a core region and a layered region overlying the core region. The layered region may include overlapping layered sections surrounding the core region. The core region may include a core region composition and a first layered section may include a first layered section composition. The first layered section composition may be different than the core region composition.

According to another aspect of the invention described herein, a plurality of porous ceramic particles may include an average porosity of at least about 0.01 cc/g and not greater than about 1.6 cc/g. The plurality of porous ceramic particles may further include an average particle size of at least about 200 microns and not greater than about 4000 microns. Each ceramic particle of the plurality of porous ceramic particles may include a cross-sectional structure including a core region and a layered region overlying the core region. The plurality of porous ceramic particles may be formed by a spray fluidization forming process operating in a batch mode. The spray fluidization forming process may include a first batch spray fluidization forming cycle. The first batch spray fluidization forming cycle may include repeatedly dispensing finely dispersed droplets of a first coating fluid onto air borne porous ceramic particles. The ceramic particles may include a core region composition and the first coating fluid may include a first coating material composition. The first coating material composition may be different than the core region composition.

According to another aspect of the invention described herein, a method of forming a batch of porous ceramic particles may include preparing an initial batch of ceramic particles. The initial batch of ceramic particles may have an initial particle size distribution span IPDS equal to (Id₉₀−Id₁₀)/Id₅₀, where Id₉₀ is equal to a d₉₀ particle size distribution measurement of the initial batch of ceramic particles, Id₁₀ is equal to a d₁₀ particle size distribution measurement of the initial batch of ceramic particles and Id₅₀ is equal to a d₅₀ particle size distribution measurement of the initial batch of ceramic particles. The method may further include forming the initial batch of ceramic particles into a processed batch of porous ceramic particles using a spray fluidization forming process that may include a first batch spray fluidization forming cycle. The processed batch of porous ceramic particles may have a processed particle size distribution span PPDS equal to (Pd₉₀−Pd₁₀)/Pd₅₀, where Pd₉₀ is equal to a d₉₀ particle size distribution measurement of the processed batch of porous ceramic particles, Pd₁₀ is equal to the d₁₀ particle size distribution measurement of the processed batch of porous ceramic particles and Pd₅₀ is equal to a d₅₀ particle size distribution measurement of the processed batch of porous ceramic particles. The ratio IPDS/PPDS for the forming of the initial batch of ceramic particles into the processed batch of porous ceramic particles may be at least about 0.90. The first batch spray fluidization forming cycle may include repeatedly dispensing finely dispersed droplets of a first coating fluid onto air borne porous ceramic particles. The ceramic particles may include a core region composition and the first coating fluid may include a first coating material composition. The first coating material composition may be different than the core region composition.

According to still another aspect of the invention described herein, a method of forming a plurality of porous ceramic particles may include forming the plurality of porous ceramic particles using a spray fluidization forming process conducted in a batch mode. The batch mode may include a batch spray fluidization forming cycle. The plurality of porous ceramic particles formed by the spray fluidization forming process may include an average porosity of at least about 0.01 cc/g and not greater than about 1.60 cc/g. The plurality of porous ceramic particles formed by the spray fluidization forming process may further include an average particle size of at least about 200 microns and not greater than about 4000 microns. Each ceramic particle of the plurality of porous ceramic particles may include a cross-sectional structure including a core region and a layered region overlying the core region. The layered region may include a first layered section surrounding the core region. The core region may include a core region composition and the first layered section of the layered region may include a first layered section composition. The first layered section composition may be different than the first material.

According to another aspect of the invention described herein, a method of forming a catalyst carrier may include forming a porous ceramic particle using a spray fluidization forming process that may include a batch spray fluidization forming process. The porous ceramic particle may have a particle size of at least about 200 microns and not greater than about 4000 microns. The method may further include sintering the porous ceramic particle at a temperature of at least about 350° C. and not greater than about 1400° C. The first batch spray fluidization forming cycle may include repeatedly dispensing finely dispersed droplets of a first coating fluid onto air borne porous ceramic particles. The ceramic particles may include a core region composition and the first coating fluid may include a first coating material composition. The first coating material composition may be different than the core region composition.

### BRIEF DESCRIPTION OF THE DRAWINGS

The present disclosure may be better understood, and its numerous features and advantages made apparent to those skilled in the art by referencing the accompanying drawings.

FIG. 1 includes a flow chart illustrating an embodiment of a process for forming a batch of porous ceramic particles;

FIGS. 2A and 2B include graph representations illustrating an initial particle size distribution span and a processed particle size distribution span for a batch of porous ceramic particles;

FIG. 3 includes a flow chart illustrating other embodiments of a process for forming a batch of porous ceramic particles;

FIG. 4 includes an image of a microstructure of an embodiment of a porous ceramic particle illustrating a core region and a layered region of the particle;

FIG. 5 includes an illustration of an embodiment of a porous ceramic particle showing a core region and a layered region with multiple layered sections of the particle;

FIGS. 6-11 include images of microstructures of embodiments of porous ceramic particle;

FIG. 12 includes an image of a microstructure of a catalyst carrier formed according to embodiments described herein;

FIG. 13A includes an energy-dispersive X-ray spectroscopic image of the catalyst carrier showing the concentration of zirconia throughout a cross-sectional image of a catalyst carrier formed according to embodiments described herein;

FIG. 13B includes a plot showing the concentration of zirconia relative to the location within the cross-sectional image of a catalyst carrier formed according to embodiments described herein;

FIG. 14 includes a plot showing the concentration of alumina relative to the location within the cross-sectional image of a catalyst carrier formed according to embodiments described herein; and

FIG. 15 includes a plot showing both the concentration of zirconia and the concentration of alumina relative to the location within the cross-sectional image of a catalyst carrier formed according to embodiments described herein.

The use of the same reference symbols in different drawings indicates similar or identical items.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

A plurality of porous ceramic particles and a method of forming a plurality of porous ceramic particles are described herein. Embodiments described herein relate to the production of porous ceramic particles by a spray fluidization forming process. In particular, a batch spray fluidization forming process is proposed for the production of a batch of spherical porous particles having a narrow size distribution. It has been found that by employing a batch spray fluidization forming process, spherical particles having a narrow size distribution can be produced efficiently and economically. Further, by using an iterative growth process and a divided scheme that may include multiple batch production cycles, large particle sizes can be produced while maintaining the narrow size distribution. Also, by using an iterative growth process and a divided scheme that may include multiple batch production cycles, porous particles can be formed with distinct layered regions having distinct compositions.

Dense, spherical ceramic particles may be prepared by spray fluidization. However, such particles are prepared using a continuous spray fluidization forming process. Producing ceramic particles having the various desired qualities noted above, such as, a particular porosity and with a narrow size distributions using a continuous spray fluidization forming process requires a complex manufacturing process that may include post-process mechanical screening operations (i.e., cutting, grinding or filtering) to reduce and normalize the average particle size of oversized fractions of the ceramic particles. These fractions must then be recycled back to the continuous process or be counted as a lost material. Such continuous operations may therefore require excessive expense and may only be practical in certain large production situations.

According to particular embodiments described herein, a plurality of porous ceramic particles may be formed using a spray fluidization forming process operating in a batch mode. Forming a plurality of porous ceramic particles using such a process uniformly increases the average particle size of a batch of ceramic particles while maintaining a relatively narrow particle size distribution and a uniform shape of all particles in the batch of porous ceramic particles.

According to particular embodiments, a spray fluidization forming process operating in a batch mode may be defined as any spray fluidization forming process where a first finite number of ceramic particles (i.e., an initial batch) begins the spray fluidization forming process at the same time and are formed into a second finite number of porous ceramic particles (i.e., a processed batch) that all end the spray fluidization forming process at the same time. According to still other embodiments, a spray fluidization forming process operating in a batch mode may be further defined as being non-cyclic or non-continuous, meaning that the ceramic particles are not continuously removed and re-introduced into the spray fluidization forming process at different times than other ceramic particles in the same batch.

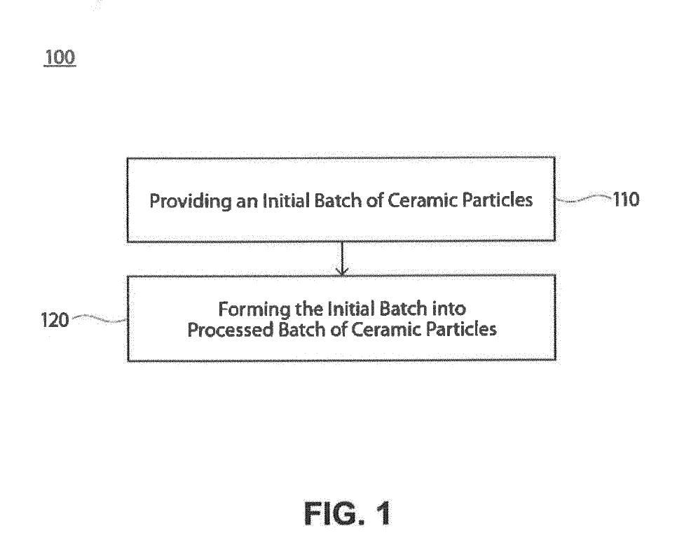

According to yet other embodiments, a spray fluidization forming process operating in a batch mode may include at least a first batch spray fluidization forming cycle. For purposes of illustration, FIG. 1 includes a flow chart showing a batch spray fluidization forming cycle according to embodiments described herein. As illustrated in FIG. 1, a batch spray fluidization forming cycle 100 for forming a plurality of porous ceramic particles may include a step 110 of providing an initial batch of ceramic particles and a step 120 of forming the initial batch of ceramic particles into a processed batch of porous ceramic particles using spray fluidization. It will be appreciated that, as used herein, the term batch refers to a finite number of particles that may undergo a forming process cycle as described herein.

According to particular embodiments, the initial batch of ceramic particles provided in step 110 may each include a core region composition. According to yet other embodiments, the core region composition may include a particular material or a combination of particular materials. According to still other embodiments, the material or materials included in the core region composition may include a ceramic material. According to still other embodiments, the core region of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the core region composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to still other embodiments, the initial batch of ceramic particles may include monolithic seed particles. According to yet other embodiments, the initial batch of ceramic particles may include monolithic seed particles with a layered region overlying a surface of the seed particles. It will be appreciated that, depending of the cycle of the spray fluidization forming process, the initial batch of ceramic particles may include previously unprocessed particles or particles that have undergone a previous forming process cycle.

According to still other embodiments, the initial batch of ceramic particles provided in step 110 may have a particular average particle size (Id₅₀). For example, the initial batch of ceramic particles may have an Id₅₀ of at least about 100 microns, such as, at least about 200 microns, at least about 300 microns, at least about 400 microns, at least about 500 microns, at least about 600 microns, at least about 700 microns, at least about 800 microns, at least about 900 microns, at least about 1000 microns, at least about 1100 microns, at least about 1200 microns, at least about 1300 microns, at least about 1400 microns or even at least about 1490 microns. According to still other embodiments, the initial batch of ceramic particles may have an Id₅₀ of not greater than about 1500 microns, such as, not greater than about 1400 microns, not greater than about 1300 microns, not greater than about 1200 microns, not greater than about 1100 microns, not greater than about 1000 microns, not greater than about 900 microns, not greater than about 800 microns, not greater than about 700 microns, not greater than about 600 microns, not greater than about 500 microns, not greater than about 400 microns, not greater than about 300 microns, not greater than about 200 microns, or even not greater than about 150 microns. It will be appreciated that the initial batch of ceramic particles may have an Id₅₀ of any value between any of the minimum and maximum values noted above. It will be further appreciated that the initial batch of ceramic particles may have an Id₅₀ of any value within a range between any of the minimum and maximum values noted above.

According to other embodiments, the processed batch of porous ceramic particles formed from the initial batch of ceramic particles in step 120 may include any desired ceramic material suitable for forming porous ceramic particles, such as, for example, alumina, zirconia, titania, silica or a combination thereof. According to still other embodiments, the initial batch of ceramic particles in step 120 may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof. According to still other embodiments, the processed batch of porous ceramic particles may include monolithic seed particles with a layered region overlying a surface of the seed particles.

According to still other embodiments, the processed batch of porous ceramic particles formed from the initial batch of ceramic particles in step 120 may have a particular average particle size (Pd₅₀). For example, the processed batch of porous ceramic particles may have a Pd₅₀ of at least about 200 microns, such as, at least about 300 microns, at least about 400 microns, at least about 500 microns, at least about 600 microns, at least about 700 microns, at least about 800 microns, at least about 900 microns, at least about 1000 microns, at least about 1100 microns, at least about 1200 microns, at least about 1300 microns, at least about 1400 microns, at least about 1500 microns, at least about 1600 microns, at least about 1700 microns, at least about 1800 microns, at least about 1900 microns, or even at least about 1950 microns. According to still other embodiments, the processed batch of porous ceramic particles may have a Pd₅₀ of not greater than about 4000 microns, such as, not greater than about 3900 microns, not greater than about 3800 microns, not greater than about 3700 microns, not greater than about 3600 microns, not greater than about 3500 microns, not greater than about 3400 microns, not greater than about 3300 microns, not greater than about 3200 microns, not greater than about 3100 microns, not greater than about 3000 microns, not greater than about 2900 microns, not greater than about 2800 microns, not greater than about 2700 microns, not greater than about 2600 microns, not greater than about 2500 microns, not greater than about 2400 microns, not greater than about 2300 microns, not greater than about 2200 microns, not greater than about 2100 microns, not greater than about 2000 microns not greater than about 1900 microns, not greater than about 1800 microns, not greater than about 1700 microns, not greater than about 1600 microns, not greater than about 1500 microns, not greater than about 1400 microns, not greater than about 1300 microns, not greater than about 1200 microns, not greater than about 1100 microns, not greater than about 1000 microns, not greater than about 900 microns, not greater than about 800 microns, not greater than about 700 microns, not greater than about 600 microns, not greater than about 500 microns, not greater than about 400 microns, not greater than about 300 microns, not greater than about 200 microns, or even not greater than about 150 microns. It will be appreciated that the processed batch of porous ceramic particles may have a Pd₅₀ of any value between any of the minimum and maximum values noted above. It will be further appreciated that the processed batch of porous ceramic particles may have a Pd₅₀ of any value within a range between any of the minimum and maximum values noted above.

It will be appreciated that as used herein, and in particular as used in reference to step 120 of cycle 100, a first batch spray fluidization forming cycle may include, generally, any particle forming or growing process where initial or seed particles are fluidized in a stream of heated gas and introduced into a solid material that has been atomized in a liquid. The atomized material collides with the initial or seed particles and, as the liquid evaporates, the solid material is deposited on the outer surface of the initial or seed particles forming a layer or coating that increases the general size or shape of the seed particles. As the particles repeatedly circulate in and out of the atomized material, multiple layers of the solid material are formed or deposited on the initial or seed particles.

According to particular embodiments, spray fluidization may be described as repeatedly dispensing finely dispersed droplets of a coating fluid onto air borne ceramic particles to form the processed batch of porous ceramic particles. It may be further appreciated that a spray fluidization forming process as described herein may not include any form of or additional mechanism for manually reducing the size of particles during the spray fluidization forming process.

According to still other embodiments, a first batch spray fluidization forming cycle may be described as repeatedly dispensing finely dispersed droplets of a first coating fluid onto air borne ceramic particles to form the processed batch of porous ceramic particle.

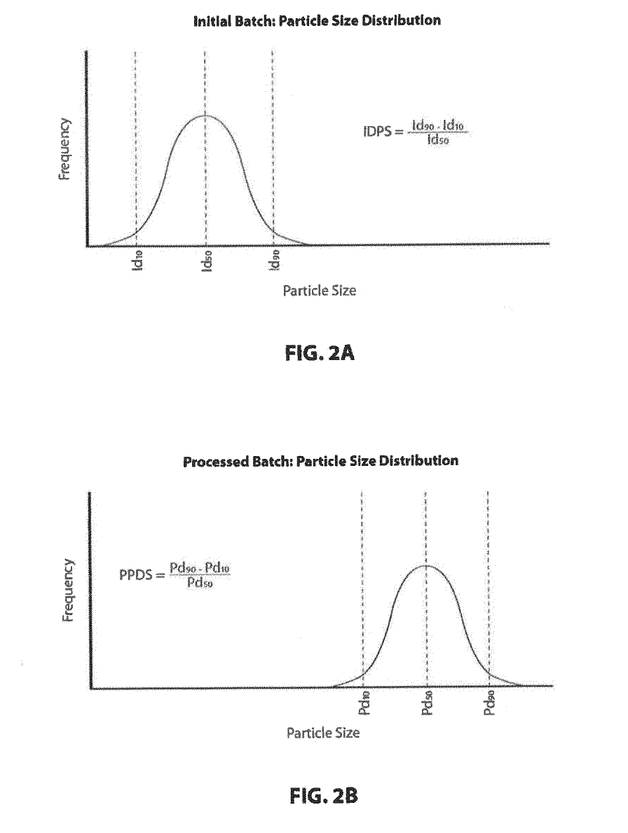

Referring back to FIG. 1, according to certain embodiments described herein, the initial batch of ceramic particles provided during step 110 may be described as having an initial particle size distribution span IPDS and the processed batch of porous ceramic particles formed during step 120 may be described as having a processed particle size distribution span PPDS. For purposes of illustration, FIGS. 2A and 2B include a graph representation of the initial particle size distribution for an initial batch of ceramic particles and the processed particle size distribution for a processed batch of porous ceramic particles, respectively. As shown in FIG. 2A, the initial particle size distribution span IPDS of the initial batch of ceramic particles is equal to (Id₉₀−Id₁₀)/Id₅₀, where Id₉₀ is equal to a d₉₀ particle size distribution measurement of the initial batch of ceramic particles, Id₁₀ is equal to a d₁₀ particle size distribution measurement of the initial batch of ceramic particles and Id₅₀ is equal to a d₅₀ particle size distribution measurement of the initial batch of ceramic particles. As shown in FIG. 2B, the processed particle size distribution span PPDS of the processed batch of porous ceramic particles is equal to (Pd₉₀−Pd₁₀)/Pd₅₀, where Pd₉₀ is equal to a d₉₀ particle size distribution measurement of the processed batch of porous ceramic particles, Pd₁₀ is equal to a d₁₀ particle size distribution measurement of the processed batch of porous ceramic particles and Pd₅₀ is equal to a d₅₀ particle size distribution measurement of the processed batch of porous ceramic particles.

All particle size distribution measurements described herein are determined using a Retsch Technology's CAMSIZER® (for example, the model 8524). The CAMSIZER® measures the two-dimensional projection of the microsphere cross-sections through optical imaging. The projection is converted to a circle of equivalent diameter. The sample is fed to the instrument with a 75 mm width feeder, using the guidance sheet in the top of the sample chamber, with maximum obscuration set at 1.0%. The measurements are done with both the Basic and Zoom CCD cameras. An image rate of 1:1 is used. All particles in a representative sample of a batch are included in the calculation; no particles are ignored because of size or shape limits. A measurement typically will image several thousand to several million particles. Calculations are done using the instrument's statistical functions included in CAMSIZER® software version 5.1.27.312. An “xFe_min” particle model is used, with the shape settings for “spherical particles.” Statistics are calculated on a volume basis.

According to a certain embodiment described herein, the cycle 100 of forming a plurality of porous ceramic particles may include maintaining a particular ratio IPDS/PPDS for the forming of the initial batch of ceramic particles into the processed batch of porous ceramic particles. For example, the method of forming the initial batch of ceramic particles into the processed batch of porous ceramic particles may have a ratio IPDS/PPDS of at least about 0.90, such as, at least about 1.00, at least about 1.10, at least about 1.20, at least about 1.30, at least about 1.40, at east about 1.50, at least about 1.60, at least about 1.70, at least about 1.80, at least about 1.90, at least about 2.00, at least about 2.50, at least about 3.00, at least about 3.50, at least about 4.00 or even at least about 4.50. According to still other embodiments, the method of forming the initial batch of ceramic particles into the processed batch of porous ceramic particles may have a ratio IPDS/PPDS of not greater than about 10.00, such as, not greater than about 9.00, not greater than about 8.00, not greater than about 7.00, not greater than about 6.00, not greater than about 5.00, not greater than about 4.50 or even not greater than about 4.00. It will be appreciated that the method of forming the initial batch of ceramic particles into the processed batch of porous ceramic particles may have a ratio IPDS/PPDS of any value between any of the minimum and maximum values noted above. It will be further appreciated that the method of forming the initial batch of ceramic particles into the processed batch of porous ceramic particles may have a ratio IPDS/PPDS of any value within a range between any of the minimum and maximum values noted above.

According to another particular embodiment, the initial batch of ceramic particles may have a particular initial particle size distribution span IPDS. As noted herein, the initial particle size distribution span is equal to (Id₉₀−Id₁₀)/Id₅₀, where Id₉₀ is equal to a d₉₀ particle size distribution measurement of the initial batch of ceramic particles, Id₁₀ is equal to a d₁₀ particle size distribution measurement of the initial batch of ceramic particles and Id₅₀ is equal to a d₅₀ particle size distribution measurement of the initial batch of ceramic particles. For example, the initial batch of ceramic particles may have an IPDS of not greater than about 2.00, such as, not greater than about 1.90, not greater than about 1.80, not greater than about 1.70, not greater than about 1.60, not greater than about 1.50, not greater than about 1.40, not greater than about 1.30, not greater than about 1.20, not greater than about 1.10, not greater than about 1.00, not greater than about 0.90, not greater than about 0.80, not greater than about 0.70, not greater than about 0.60, not greater than about 0.50, not greater than about 0.40, not greater than about 0.30, not greater than about 0.20, not greater than about 0.10, not greater than about 0.05 or even substantially no initial particle size distribution span where IPDS is equal to zero. According to another particular embodiment, the initial batch of ceramic particles may have an IPDS of at least about 0.01, such as, at least about 0.05, at least about 0.10, at least about 0.20, at least about 0.30, at least about 0.40, at least about 0.50, at least about 0.60 or even at least about 0.70. It will be appreciated that the initial batch of ceramic particles may have an IPDS of any value between any of the minimum and maximum values noted above. It will be further appreciated that the initial batch of ceramic particles may have an IPDS of any value within a range between any of the minimum and maximum values noted above.

According to a yet other embodiments, the processed batch of porous ceramic particles may have a particular processed particle size distribution span PPDS. As noted herein, the processed particle size distribution span is equal to (Pd₉₀−Pd₁₀)/Pd₅₀, where Pd₉₀ is equal to a d₉₀ particle size distribution measurement of the processed batch of porous ceramic particles, Pd₁₀ is equal to a d₁₀ particle size distribution measurement of the processed batch of porous ceramic particles and Pd₅₀ is equal to a d₅₀ particle size distribution measurement of the processed batch of porous ceramic particles. For example, the processed batch of porous ceramic particles may have a PPDS of not greater than about 2.00, such as, not greater than about 1.90, not greater than about 1.80, not greater than about 1.70, not greater than about 1.60, not greater than about 1.50, not greater than about 1.40, not greater than about 1.30, not greater than about 1.20, not greater than about 1.10, not greater than about 1.00, not greater than about 0.90, not greater than about 0.80, not greater than about 0.70, not greater than about 0.60, not greater than about 0.50, not greater than about 0.40, not greater than about 0.30, not greater than about 0.20, not greater than about 0.10, not greater than about 0.05 or even substantially no processed particle size distribution span where PPDS is equal to zero. According to another particular embodiment, the processed batch of porous ceramic particles may have a PPDS of at least about 0.01, such as, at least about 0.05, at least about 0.10, at least about 0.20, at least about 0.30, at least about 0.40, at least about 0.50, at least about 0.60 or even at least about 0.70. It will be appreciated that the processed batch of porous ceramic particles may have a PPDS of any value between any of the minimum and maximum values noted above. It will be further appreciated that the processed batch of porous ceramic particles may have a PPDS of any value within a range between any of the minimum and maximum values noted above.

According to yet other embodiments, the average particle size of the processed batch of porous ceramic particles (Pd₅₀) may be greater than the average particle size of the initial batch of ceramic particles (Id₅₀). According to still other embodiments, the average particle size of the processed batch of porous ceramic particles (Pd₅₀) may be a particular percentage greater than the average particle size of the initial batch of ceramic particles (Id₅₀). For example, the average particle size of the processed batch of porous ceramic particles (Pd₅₀) may be at least about 10% greater than the average particle size of the initial batch of ceramic particles (Id₅₀), such as, at least about 20% greater than the average particle size of the initial batch of ceramic particles (Id₅₀), at least about 30% greater than the average particle size of the initial batch of ceramic particles (Id₅₀), at least about 40% greater than the average particle size of the initial batch of ceramic particles (Id₅₀), at least about 50% greater than the average particle size of the initial batch of ceramic particles (Id₅₀), at least about 60% greater than the average particle size of the initial batch of ceramic particles (Id₅₀), at least about 70% greater than the average particle size of the initial batch of ceramic particles (Id₅₀), at least about 80% greater than the average particle size of the initial batch of ceramic particles (Id₅₀), at least about 90% greater than the average particle size of the initial batch of ceramic particles (Id₅₀), at least about 100% greater than the average particle size of the initial batch of ceramic particles (Id₅₀), at least about 120% greater than the average particle size of the initial batch of ceramic particles (Id₅₀), at least about 140% greater than the average particle size of the initial batch of ceramic particles (Id₅₀), at least about 160% greater than the average particle size of the initial batch of ceramic particles (Id₅₀), at least about 180% greater than the average particle size of the initial batch of ceramic particles (Id₅₀), at least about 200% greater than the average particle size of the initial batch of ceramic particles (Id₅₀), at least about 220% greater than the average particle size of the initial batch of ceramic particles (Id₅₀), at least about 240% greater than the average particle size of the initial batch of ceramic particles (Id₅₀), at least about 260% greater than the average particle size of the initial batch of ceramic particles (Id₅₀), at least about or even at least about 280% greater than the average particle size of the initial batch of ceramic particles (Id₅₀). According to still other embodiments, the average particle size of the processed batch of porous ceramic particles (Pd₅₀) may be not greater than about 300% greater than the average particle size of the initial batch of ceramic particles (Id₅₀), such as, not greater than about 280% greater than the average particle size of the initial batch of ceramic particles (Id₅₀), not greater than about 260% greater than the average particle size of the initial batch of ceramic particles (Id₅₀), not greater than about 240% greater than the average particle size of the initial batch of ceramic particles (Id₅₀), not greater than about 220% greater than the average particle size of the initial batch of ceramic particles (Id₅₀), not greater than about 200% greater than the average particle size of the initial batch of ceramic particles (Id₅₀), not greater than about 180% greater than the average particle size of the initial batch of ceramic particles (Id₅₀), not greater than about 160% greater than the average particle size of the initial batch of ceramic particles (Id₅₀), not greater than about 140% greater than the average particle size of the initial batch of ceramic particles (Id₅₀), not greater than about 120% greater than the average particle size of the initial batch of ceramic particles (Id₅₀), not greater than about 100% greater than the average particle size of the initial batch of ceramic particles (Id₅₀), not greater than about 90% greater than the average particle size of the initial batch of ceramic particles (Id₅₀), not greater than about 80% greater than the average particle size of the initial batch of ceramic particles (Id₅₀), not greater than about 70% greater than the average particle size of the initial batch of ceramic particles (Id₅₀), not greater than about 60% greater than the average particle size of the initial batch of ceramic particles (Id₅₀), not greater than about 50% greater than the average particle size of the initial batch of ceramic particles (Id₅₀), not greater than about 40% greater than the average particle size of the initial batch of ceramic particles (Id₅₀), not greater than about 30% greater than the average particle size of the initial batch of ceramic particles (Id₅₀) or even not greater than about 20% greater than the average particle size of the initial batch of ceramic particles (Id₅₀). It will be appreciated that the processed batch of porous ceramic particles may have a Pd₅₀ of any percentage greater than the average particle size of the initial batch of ceramic particles (Id₅₀) between any of the minimum and maximum values noted above. It will be further appreciated that the processed batch of porous ceramic particles may have a Pd₅₀ of any percentage greater than the average particle size of the initial batch of ceramic particles (Id₅₀) within a range between any of the minimum and maximum values noted above.

According to yet other embodiments, the initial batch of ceramic particles may have a particular average sphericity. For example, the initial particles may have an average sphericity of at least about 0.80, such as, at least about 0.82, at least about 0.85, at least about 0.87, at least about 0.90, at least about 0.92 or even at least about 0.94. According to still other embodiments, the initial batch of ceramic particles may have an average sphericity of not greater than about 0.99, such as, not greater than about 0.95, not greater than about 0.93, not greater than about 0.90, not greater than about 0.88, not greater than about 0.85, not greater than about 0.83 or even not greater than about 0.81. It will be appreciated that the initial batch of ceramic particles may have a sphericity of any value between any of the minimum and maximum values noted above. It will be further appreciated that the initial batch of ceramic particles may have a sphericity of any value within a range between any of the minimum and maximum values noted above. It will also be appreciated that sphericity as described herein may be measured using CAMSIZER® Shape Analysis.

According to yet other embodiments, the processed batch of porous ceramic particles may have a particular average sphericity. For example, the processed batch of porous ceramic particles may have an average sphericity of at least about 0.80, such as, at least about 0.82, at least about 0.85, at least about 0.87, at least about 0.9, at least about 0.92 or even at least about 0.94. According to still other embodiments, the processed batch of porous ceramic particles may have an average sphericity of not greater than about 0.99, such as, not greater than about 0.95, not greater than about 0.93, not greater than about 0.90, not greater than about 0.88, not greater than about 0.85, not greater than about 0.83 or even not greater than about 0.81. It will be appreciated that the processed batch of porous ceramic particles may have a sphericity of any value between any of the minimum and maximum values noted above. It will be further appreciated that the processed batch of porous ceramic particles may have a sphericity of any value within a range between any of the minimum and maximum values noted above. It will also be appreciated that sphericity as described herein may be measured using CAMSIZER® Shape Analysis.

According to still other embodiments, the processed batch of porous ceramic particles may have a particular porosity. For example, the processed batch of porous ceramic particles may have an average porosity of at least about 0.01 cc/g, such as, at least about 0.05 cc/g, at least about 0.10 cc/g, at least about 0.25 cc/g, at least about 0.50 cc/g, at least about 0.75 cc/g, at least about 1.00 cc/g, at least about 1.10 cc/g, at least about 1.20 cc/g, at least about 1.30 cc/g, at least about 1.40 cc/g, at least about 1.50 cc/g or even at least about 1.55 cc/g. According to still other embodiments, the processed batch of porous ceramic particles may have an average porosity of not greater than about 1.60 cc/g, such as, not greater than about 1.55 cc/g, not greater than about 1.50 cc/g, not greater than about 1.45 cc/g, not greater than about 1.40 cc/g, not greater than about 1.35 cc/g, not greater than about 1.30 cc/g, not greater than about 1.25 cc/g, not greater than about 1.20 cc/g, not greater than about 1.15 cc/g, not greater than about 1.10 cc/g, not greater than about 1.05 cc/g, not greater than about 1.00 cc/g, not greater than about 0.95 cc/g, not greater than about 0.90 cc/g or even not greater than about 0.85 cc/g. It will be further appreciated that the processed batch of porous ceramic particles may have a porosity of any value within a range between any of the minimum and maximum values noted above. It will also be appreciated that porosity may be referred to as pore volume or pore size distribution. Porosity, pore volume or pore size distribution as described herein is determined by mercury intrusion using pressures from 25 to 60,000 psi, using a Micrometrics Autopore 9500 model (130° contact angle, mercury with a surface tension of 0.480 N/m, and no correction for mercury compression).

According to yet other embodiments, the number of ceramic particles that make up the processed batch of porous ceramic particles may be equal to a particular percentage of the number of ceramic particles that make up the initial batch of ceramic particles. For example, the number of ceramic particles in the processed batch may be equal to at least about 80% of the number of ceramic particles in the initial batch, such as, at least about 85% of the number of ceramic particles in the initial batch, at least about 90% of the number of ceramic particles in the initial batch, at least about 91% of the number of ceramic particles in the initial batch, at least about 92% of the number of ceramic particles in the initial batch, at least about 93% of the number of ceramic particles in the initial batch, at least about 94% of the number of ceramic particles in the initial batch, at least about 95% of the number of ceramic particles in the initial batch, at least about 96% of the number of ceramic particles in the initial batch, at least about 97% of the number of ceramic particles in the initial batch, at least about 98% of the number of ceramic particles in the initial batch or even at least about 99% of the number of ceramic particles in the initial batch. According to yet another particular embodiment, the number of ceramic particles in the processed batch may be equal to the number of ceramic particles in the initial batch. It will be appreciated that the number of ceramic particles in the processed batch may be equal to any percentage of the number of ceramic particles in the initial batch between any of the minimum and maximum values noted above. It will be further appreciated that the number of ceramic particles in the processed batch may be equal to any percentage of the number of ceramic particles in the initial batch between any of the minimum and maximum values noted above.

According to still other embodiments, a batch spray fluidization forming cycle of a spray fluidization forming process operating in a batch made may include initiating spray fluidization of the entire initial batch of ceramic particles, spray fluidizing the entire initial batch of ceramic particles to form the entire processed batch of porous ceramic particles, and terminating the spray fluidization of the entire processed batch.

According to still other embodiments, a spray fluidization forming process operating in a batch mode may include conducting spray fluidization on the entire initial batch of ceramic particles for predetermined period of time where all ceramic particles in the initial batch begin the forming process at the same time and finish the forming process at the same time. For example, the spray fluidization forming process may last at least about 10 minutes, such as, at least about 30 minutes, at least about 60 minutes, at least about 90 minutes, at least about 120 minutes, at least about 240 minutes, at least about 360 minutes, at least about 480 minutes or even at least about 600 minutes. According to still other embodiments, the spray fluidization forming process may last not greater than about 720 minutes, such as, not greater than about 600 minutes, not greater than about 480 minutes, not greater than about 360 minutes, not greater than about 240 minutes, not greater than about 120 minutes, not greater than about 90 minutes, not greater than about 60 minutes or even not greater than about 30 minutes. It will be appreciated that the spray fluidization forming process may last any number of minutes between any of the minimum and maximum values noted above. It will be further appreciated that the spray fluidization forming process may last any number of minutes within a range between any of the minimum and maximum values noted above.

According to still other embodiments, a batch spray fluidization forming cycle of a spray fluidization forming process operating in a batch mode may include conducting spray fluidization on the entire initial batch of ceramic particles for predetermined period of time where all ceramic particles in the initial batch begin the forming process at the same time and finish the forming process at the same time. For example, the batch spray fluidization forming cycle may last at least about 10 minutes, such as, at least about 30 minutes, at least about 60 minutes, at least about 90 minutes, at least about 120 minutes, at least about 240 minutes, at least about 360 minutes, at least about 480 minutes or even at least about 600 minutes. According to still other embodiments, the batch spray fluidization forming cycle may last not greater than about 720 minutes, such as, not greater than about 600 minutes, not greater than about 480 minutes, not greater than about 360 minutes, not greater than about 240 minutes, not greater than about 120 minutes, not greater than about 90 minutes, not greater than about 60 minutes or even not greater than about 30 minutes. It will be appreciated that the batch spray fluidization forming cycle may last any number of minutes between any of the minimum and maximum values noted above. It will be further appreciated that the batch spray forming fluidization forming cycle may last any number of minutes within a range between any of the minimum and maximum values noted above.

Again referring back to FIG. 1, according to particular embodiments, the step 120 of forming the initial batch of ceramic particles into the processed batch of porous ceramic particles may further include sintering the porous ceramic particles after the spray fluidization forming process is complete. Sintering the processed batch of porous ceramic particles may occur at a particular temperature. For example, the processed batch of porous ceramic particle may be sintered at a temperature of at least about 350° C., such as, at least about 375° C., at least about 400° C., at least about 425° C., at least about 450° C., at least about 475° C., at least about 500° C., at least about 525° C., at least about 550° C., at least about 575° C., at least about 600° C., at least about 625° C., at least about 650° C., at least about 675° C., at least about 700° C., at least about 725° C., at least about 750° C., at least about 775° C., at least about 800° C., at least about 825° C., at least about 850° C., at least about 875° C., at least about 900° C., at least about 925° C., at least about 950° C., at least about 975° C., at least about 1000° C., at least about 1100° C., at least about 1200° C. or even at least about 1300° C. According to still other embodiments, the processed batch of porous ceramic particle may be sintered at a temperature of not greater than about 1400° C., such as, not greater than about 1300° C., not greater than about 1200° C., not greater than about 1100° C., not greater than about 1000° C., not greater than about 975° C., not greater than about 950° C., not greater than about 925° C., not greater than about 900° C., not greater than about 875° C., not greater than about 850° C., not greater than about 825° C., not greater than about 800° C., not greater than about 775° C., not greater than about 750° C., not greater than about 725° C., not greater than about 700° C., not greater than about 675° C., not greater than about 650° C., not greater than about 625° C., not greater than about 600° C., not greater than about 575° C., not greater than about 550° C., not greater than about 525° C., not greater than about 500° C., not greater than about 475° C., not greater than about 450° C., not greater than about 425° C., not greater than about 400° C. or even not greater than about 375° C. It will be appreciated that the processed batch of porous ceramic particles may be sintered at any temperature between any of the minimum and maximum values noted above. It will be further appreciated that the spray fluidization forming process may last any number of minutes within a range between any of the minimum and maximum values noted above.

Referring to still other embodiments, a plurality of porous ceramic particles formed by a spray fluidization forming process operating in a batch mode according to embodiments described herein may have a particular average porosity. For example, a plurality of porous ceramic particles may have an average porosity of at least about 0.01 cc/g, such as, at least about 0.05 cc/g, at least about 0.10 cc/g, at least about 0.25 cc/g, at least about 0.50 cc/g, at least about 0.75 cc/g, at least about 1.00 cc/g, at least about 1.10 cc/g, at least about 1.20 cc/g, at least about 1.30 cc/g, at least about 1.40 cc/g, at least about 1.50 cc/g or even at least about 1.55 cc/g. According to still other embodiments, a plurality of porous ceramic particles may have an average porosity of not greater than about 1.60 cc/g, such as, not greater than about 1.55 cc/g, not greater than about 1.50 cc/g, not greater than about 1.45 cc/g, not greater than about 1.40 cc/g, not greater than about 1.35 cc/g, not greater than about 1.30 cc/g, not greater than about 1.25 cc/g, not greater than about 1.20 cc/g, not greater than about 1.15 cc/g, not greater than about 1.10 cc/g, not greater than about 1.05 cc/g, not greater than about 1.00 cc/g, not greater than about 0.95 cc/g, not greater than about 0.90 cc/g or even not greater than about 0.85 cc/g. It will be appreciated that a plurality of porous ceramic particles may have an average porosity of any value between any of the minimum and maximum values noted above. It will be further appreciated that a plurality of porous ceramic particles may have an average porosity of any value within a range between any of the minimum and maximum values noted above.

According to still other embodiments, a plurality of porous ceramic particles formed by a spray fluidization forming process operating in a batch mode according to embodiments described herein may have a particular average particle size. For example, a plurality of porous ceramic particles may have an average particle size of at least about 100 microns, such as, at least about 200 microns, at least about 300 microns, at least about 400 microns, at least about 500 microns, at least about 600 microns, at least about 700 microns, at least about 800 microns, at least about 900 microns, at least about 1000 microns, at least about 1100 microns, at least about 1200 microns, at least about 1300 microns, at least about 1400 microns or even at least about 1490 microns. According to still other embodiments, a plurality of porous ceramic particles may have an average particle size of not greater than about 1500 microns, such as, not greater than about 1400 microns, not greater than about 1300 microns, not greater than about 1200 microns, not greater than about 1100 microns, not greater than about 1000 microns, not greater than about 900 microns, not greater than about 800 microns, not greater than about 700 microns, not greater than about 600 microns, not greater than about 500 microns, not greater than about 400 microns, not greater than about 300 microns, not greater than about 200 microns, or even not greater than about 150 microns. It will be appreciated that the plurality of porous ceramic particles may have an average particle size of any value between any of the minimum and maximum values noted above. It will be further appreciated that the plurality of porous ceramic particles may have an average particle size of any value within a range between any of the minimum and maximum values noted above.

According to yet other embodiments, a plurality of porous ceramic particles formed by a spray fluidization forming process operating in a batch mode according to embodiments described herein may have a particular average sphericity. For example a plurality of porous ceramic particles may have an average sphericity of at least about 0.80, such as, at least about 0.82, at least about 0.85, at least about 0.87, at least about 0.90, at least about 0.92 or even at least about 0.94. According to still other embodiments, a plurality of porous ceramic particles may have an average sphericity of not greater than about 0.95, such as, not greater than about 0.93, not greater than about 0.90, not greater than about 0.88, not greater than about 0.85, not greater than about 0.83 or even not greater than about 0.81. It will be appreciated that the plurality of porous ceramic particles may have a sphericity of any value between any of the minimum and maximum values noted above. It will be further appreciated that the plurality of porous ceramic particles may have a sphericity of any value within a range between any of the minimum and maximum values noted above.

According to still other particular embodiments, a spray fluidization forming process operating in a batch mode may include multiple batch spray fluidization forming cycles as described herein with reference to the cycle 100 and illustrated in FIG. 1. As further described herein with reference to the cycle 100 and illustrated in FIG. 1, each batch spray fluidization forming cycle may include a step 110 of providing an initial batch of ceramic particles and a step 120 of forming the initial batch into a processed batch of porous ceramic particles using spray fluidization. It will be appreciated that the processed batch of porous ceramic particles from any cycle may be used to form the initial batch of ceramic particles for the subsequent cycle. For example, the processed batch of porous ceramic particles formed during a first batch spray fluidization forming cycle 100 may then be used as the initial batch in a second batch spray fluidization forming cycle 100. It will also be appreciated that all description, characteristics and embodiments described herein with regard to cycle 100 as illustrated in FIG. 1 may be applied to any cycle of a multi-cycle spray fluidization forming process operating in a batch mode for forming a plurality of porous ceramic particle as described herein.

According to still other particular embodiments, a spray fluidization forming process operating in a batch mode may include a particular number of batch spray fluidization forming cycles. For example, a spray fluidization forming process operating in a batch mode may include at least 2 batch spray fluidization forming cycles, such as, at least 3 batch spray fluidization forming cycles, at least 4 batch spray fluidization forming cycles, at least 5 batch spray fluidization forming cycles, at least 6 batch spray fluidization forming cycles, at least 7 batch spray fluidization forming cycles, at least 8 batch spray fluidization forming cycles, at least 9 batch spray fluidization forming cycles or even at least 10 batch spray fluidization forming cycles. According to other embodiments, a spray fluidization forming process operating in a batch mode may include not greater than 15 batch spray fluidization forming cycles, such as, not greater than 10 batch spray fluidization forming cycles, not greater than 9 batch spray fluidization forming cycles, not greater than 8 batch spray fluidization forming cycles, not greater than 7 batch spray fluidization forming cycles, not greater than 6 batch spray fluidization forming cycles, not greater than 5 batch spray fluidization forming cycles, not greater than 4 batch spray fluidization forming cycles or even not greater than 3 batch spray fluidization forming cycles. It will be appreciate that a spray fluidization forming process operating in a batch mode may include any number of cycles between any of the minimum and maximum values noted above. It will be further appreciated that a spray fluidization forming process operating in a batch mode may include any number of cycles within a range between any of the minimum and maximum values noted above.

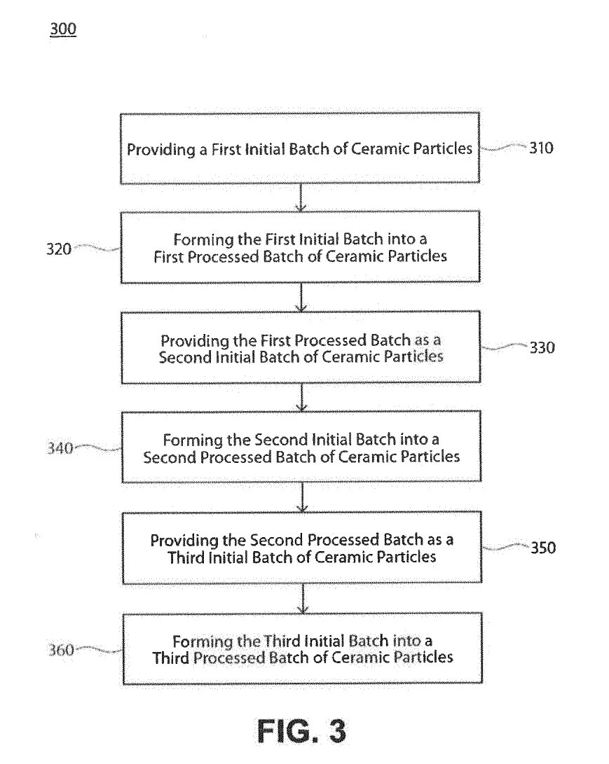

For purposes of illustration, FIG. 3 includes a flow chart showing an embodiment of a spray fluidization forming process operating in a batch mode for forming a plurality of porous ceramic particles where the spray fluidization forming process includes three batch spray fluidization forming cycles. As illustrated in FIG. 3, a process 300 for forming porous ceramic particles may include, as the first batch spray fluidization forming cycle, a step 310 of providing a first initial batch of ceramic particles and a step 320 of forming the first initial batch into a first processed batch of porous ceramic particles using spray fluidization. Next, the process 300 may include, as the second batch spray fluidization forming cycle, a step 330 of providing the first processed batch as a second initial batch of ceramic particles and a step 340 of forming the second initial batch into a second processed batch of porous ceramic particles using spray fluidization. Finally, the process 300 may include, as the third batch spray fluidization forming cycle, a step 350 of providing the second processed batch as a third initial batch of ceramic particles and a step 360 of forming the third initial batch into a third processed batch of porous ceramic particles using spray fluidization. It will be appreciated that the third processed batch may be referred to as a final processed batch.

According to certain embodiments, referring to the first batch spray fluidization forming cycle of process 300, the particles of the first initial batch of ceramic particles may include a core region composition. According to yet other embodiments, the core region composition may include a particular material or a combination of particular materials. According to still other embodiments, the material or materials included in the core region composition may include a ceramic material. According to still other embodiments, the core region of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the core region of each ceramic particle may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to still other embodiments, the first batch spray fluidization forming cycle of process 300 (i.e., steps 310-320) may include repeatedly dispensing finely dispersed droplets of a first coating fluid onto air borne ceramic particles from the first initial batch of ceramic particles to form the first processed batch of ceramic particles.

According to yet other embodiments, the first coating fluid may include a particular first coating material composition. According to yet other embodiments, the first coating material composition may include a particular material or a combination of particular materials. According to still other embodiments, the material or materials included in the first coating material composition may include a ceramic material. It will be appreciated that the ceramic material may be any desired ceramic material suitable for forming porous ceramic particles, such as, for example, alumina, zirconia, titania, silica or a combination thereof. According to still other embodiments, the first coating material composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to certain embodiments, the first coating material composition may be the same as the core region composition. It will be appreciated that when the first coating material composition is referred to as being the same as the core region composition, the first coating material composition includes the same materials at the same relative concentrations as the core region composition.

According to still other embodiments, the first coating material composition may be different than the core region composition. It will be appreciated that when the first coating material composition is referred to as being different than the core region composition, the first coating material composition includes different materials than the core region composition, different relative concentrations of materials than the core region composition or both different materials and different relative concentrations of materials than the core region composition.

According to still other embodiments, the first coating material composition may include a particular concentration of a material or particular concentrations of multiple materials as measured in volume percent for a total volume of the first coating fluid.

According to still other embodiments, the concentration of the particular material or the concentrations of the multiple materials in the first coating material composition may be held constant throughout the duration of the first batch spray fluidization forming cycle. Holding the concentration of the particular material or the concentrations of the multiple materials in the first coating material composition constant throughout the duration of the first batch spray fluidization forming cycle forms a first layered section that has a constant or generally homogeneous first layered section composition throughout the thickness of the first layered section.

According to still other embodiments, the concentration of the particular material or the concentrations of the multiple materials in the first coating material composition may be changed gradually for a portion of or throughout the duration of the first batch spray fluidization forming cycle. Gradually changing the concentration of the particular material or the concentrations of the multiple materials in the first coating material composition for a portion of or throughout the duration of the first batch spray fluidization forming cycle forms a first layered section that has non-homogenous or a gradually changing composition throughout the thickness of the first layered section.

According to still other embodiments, the second batch spray fluidization forming cycle of process 300 (i.e., steps 330-340) may include repeatedly dispensing finely dispersed droplets of a second coating fluid onto air borne ceramic particles from the first processed batch of ceramic particles to form the second processed batch of ceramic particles.

According to yet other embodiments, the second coating fluid may include a particular second coating material composition. According to yet other embodiments, the second coating material composition may include a particular material or a combination of particular materials. According to still other embodiments, the material or materials included in the second coating material composition may include a ceramic material. It will be appreciated that the ceramic material may be any desired ceramic material suitable for forming porous ceramic particles, such as, for example, alumina, zirconia, titania, silica or a combination thereof. According to still other embodiments, the second coating material composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to certain embodiments, the second coating material composition may be the same as the core region composition. It will be appreciated that when the second coating material composition is referred to as being the same as the core region composition, the second coating material composition includes the same materials at the same relative concentrations as the core region composition.

According to certain embodiments, the second coating material composition may be the same as the first coating material composition. It will be appreciated that when the second coating material composition is referred to as being the same as the first coating material composition, the second coating material composition includes the same materials at the same relative concentrations as the first coating material composition.

According to still other embodiments, the second coating material composition may be different than the core region composition. It will be appreciated that when the second coating material composition is referred to as being different than the core region composition, the second coating material composition includes different materials than the core region composition, different relative concentrations of materials than the core region composition or both different materials and different relative concentrations of materials that the core region composition.

According to still other embodiments, the second coating material composition may be different than the first coating material composition. It will be appreciated that when the second coating material composition is referred to as being different than the first coating material composition, the second coating material composition includes different materials than the first coating material composition (not including fluidization liquid), different relative concentrations of materials than the first coating material composition or both different materials and different relative concentrations of materials that the first coating material composition.

According to still other embodiments, the second coating material composition may include a particular concentration of a material or particular concentrations of multiple materials as measured in volume percent for a total volume of the second coating fluid.

According to still other embodiments, the concentration of the particular material or the concentrations of the multiple materials in the second coating material composition may be held constant throughout the duration of the second batch spray fluidization forming cycle. Holding the concentration of the particular material or the concentrations of the multiple materials in the second coating material composition constant throughout the duration of the second batch spray fluidization forming cycle forms a second layered section that has a constant or generally homogeneous second layered section composition throughout the thickness of the second layered section.

According to still other embodiments, the concentration of the particular material or the concentrations of the multiple materials in the second coating material composition may be changed gradually for a portion of or throughout the duration of the second batch spray fluidization forming cycle. Gradually changing the concentration of the particular material or the concentrations of the multiple materials in the second coating material composition for a portion of or throughout the duration of the second batch spray fluidization forming cycle forms a second layered section that has non-homogenous or a gradually changing composition throughout the thickness of the second layered section.

According to still other embodiments, the third batch spray fluidization forming cycle of process 300 (i.e., steps 350-360) may include repeatedly dispensing finely dispersed droplets of a third coating fluid onto air borne ceramic particles from the first processed batch of ceramic particles to form the third processed batch of ceramic particles.

According to yet other embodiments, the third coating fluid may include a particular third coating material composition. According to yet other embodiments, the third coating material composition may include a particular material or a combination of particular materials. According to still other embodiments, the material or materials included in the third coating material composition may include a ceramic material. It will be appreciated that the ceramic material may be any desired ceramic material suitable for forming porous ceramic particles, such as, for example, alumina, zirconia, titania, silica or a combination thereof. According to still other embodiments, the third coating material composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to certain embodiments, the third coating material composition may be the same as the core region composition. It will be appreciated that when the third coating material composition is referred to as being the same as the core region composition, the third coating material composition includes the same materials at the same relative concentrations as the core region composition.

According to certain embodiments, the third coating material composition may be the same as the first coating material composition. It will be appreciated that when the third coating material composition is referred to as being the same as the first coating material composition, the third coating material composition includes the same materials at the same relative concentrations as the first coating material composition.

According to certain embodiments, the third coating material composition may be the same as the second coating material composition. It will be appreciated that when the third coating material composition is referred to as being the same as the second coating material composition, the third coating material composition includes the same materials at the same relative concentrations as the second coating material composition.

According to still other embodiments, the third coating material composition may be different than the core region composition. It will be appreciated that when the third coating material composition is referred to as being different than the core region composition, the third coating material composition includes different materials than the core region composition, different relative concentrations of materials than the core region composition or both different materials and different relative concentrations of materials than the core region composition.

According to still other embodiments, the third coating material composition may be different than the first coating material composition. It will be appreciated that when the third coating material composition is referred to as being different than the first coating material composition, the third coating material composition includes different materials than the first coating material composition, different relative concentrations of materials than the first coating material composition or both different materials and different relative concentrations of materials than the first coating material composition.

According to still other embodiments, the third coating material composition may be different than the second coating material composition. It will be appreciated that when the third coating material composition is referred to as being different than the first coating material composition, the third coating material composition includes different materials than the second coating material composition, different relative concentrations of materials than the first coating material composition or both different materials and different relative concentrations of materials than the second coating material composition.

According to still other embodiments, the third coating material composition may include a particular concentration of a material or particular concentrations of multiple materials as measured in volume percent for a total volume of the third coating fluid.

According to still other embodiments, the concentration of the particular material or the concentrations of the multiple materials in the third coating material composition may be held constant throughout the duration of the third batch spray fluidization forming cycle. Holding the concentration of the particular material or the concentrations of the multiple materials in the third coating material composition constant throughout the duration of the third batch spray fluidization forming cycle forms a third layered section that has a constant or generally homogeneous third layered section composition throughout the thickness of the third layered section.

According to still other embodiments, the concentration of the particular material or the concentrations of the multiple materials in the third coating material composition may be changed gradually for a portion of or throughout the duration of the third batch spray fluidization forming cycle. Gradually changing the concentration of the particular material or the concentrations of the multiple materials in the third coating material composition for a portion of or throughout the duration of the third batch spray fluidization forming cycle forms a third layered section that has non-homogenous or a gradually changing composition throughout the thickness of the third layered section.

As noted according to certain embodiments herein a spray fluidization forming process operating in a batch mode may include any necessary number of batch spray fluidization forming cycles. It will be appreciated that any batch spray fluidization forming cycle may be carried out in accordance with the processes described herein in reference to the first batch spray fluidization forming cycle, the second batch spray fluidization forming cycle or the third batch spray fluidization forming cycle.

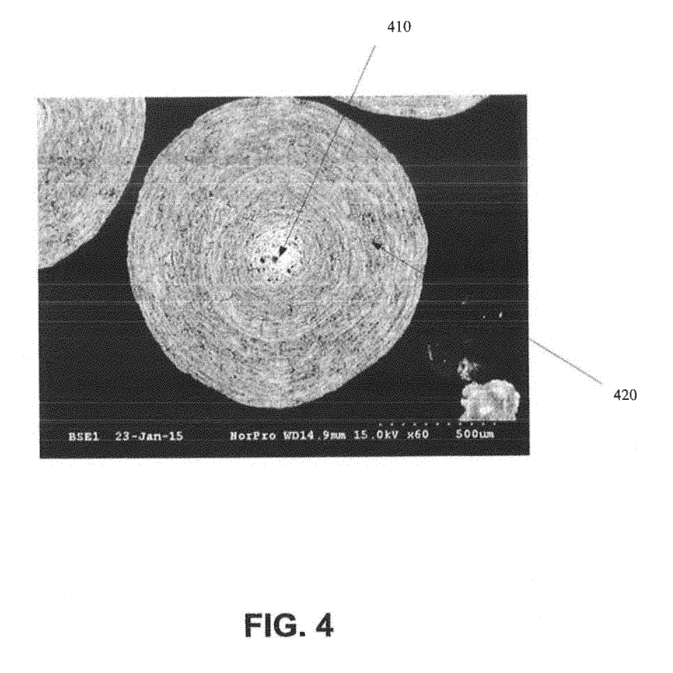

Referring now to the plurality of porous ceramic particles formed according to embodiments described herein, a plurality of porous ceramic particles may each be described as including a particular cross-section having a core region and a layered region overlying the core region. By way of illustration, FIG. 4 shows a cross-sectional image of an embodiment of a porous ceramic particle formed according to embodiments described herein. As shown in FIG. 4, a porous ceramic particle 400 may include a core region 410 and a layered region 420 overlying the core region 410.

It will be appreciated that, according to certain embodiments, the core region 410 may be referred to as a seed or initial particle. According to still other embodiments, the core region 410 may be monolithic. According to still other embodiments, the core region 410 may include a core region composition. According to yet other embodiments, the core region composition may include a particular material or a combination of particular materials. According to still other embodiments, the material or materials included in the core region composition may include a ceramic material. According to still other embodiments, the core region of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the core region composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to yet other embodiments, the layered region 420 may be referred to as an outer region or shell region overlying the core region 410. According to still other embodiments, the layered region 420 may include overlapping layers surrounding the core region 410.

According to still other embodiments, the layered region 420 may include a layered region composition. According to yet other embodiments, the layered region composition may include a particular material or a combination of particular materials. According to still other embodiments, the material or materials included in the layered region composition may include a ceramic material. According to still other embodiments, the layered region of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the layered region composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to still other embodiments, the layered region 420 may have a particular porosity. For example, the layered region 420 may have an average porosity of at least about 0.01 cc/g, such as, at least about 0.05 cc/g, at least about 0.10 cc/g, at least about 0.25 cc/g, at least about 0.50 cc/g, at least about 0.75 cc/g, at least about 1.00 cc/g, at least about 1.10 cc/g, at least about 1.20 cc/g, at least about 1.30 cc/g, at least about 1.40 cc/g, at least about 1.50 cc/g or even at least about 1.55 cc/g. According to still other embodiments, the layered region 420 may have an average porosity of not greater than about 1.60 cc/g, such as, not greater than about 1.55 cc/g, not greater than about 1.50 cc/g, not greater than about 1.45 cc/g, not greater than about 1.40 cc/g, not greater than about 1.35 cc/g, not greater than about 1.30 cc/g, not greater than about 1.25 cc/g, not greater than about 1.20 cc/g, not greater than about 1.15 cc/g, not greater than about 1.10 cc/g, not greater than about 1.05 cc/g, not greater than about 1.00 cc/g, not greater than about 0.95 cc/g, not greater than about 0.90 cc/g or even not greater than about 0.85 cc/g. It will be appreciated that the layered region may have a porosity of any value between any of the minimum and maximum values noted above. It will be further appreciated that the layered region may have a porosity of any value within a range between any of the minimum and maximum values noted above.

According to other embodiments, the layered region 420 may make up a particular volume percentage of the total volume of the porous ceramic particle 400. For example, the layered region 420 may make up at least about 50 vol % of the total volume of the porous ceramic particle 400, such as, at least about 55 vol % of the total volume of the porous ceramic particle 400, at least about 60 vol % of the total volume of the porous ceramic particle 400, at least about 65 vol % of the total volume of the porous ceramic particle 400, at least about 70 vol % of the total volume of the porous ceramic particle 400, at least about 75 vol % of the total volume of the porous ceramic particle 400, at least about 80 vol % of the total volume of the porous ceramic particle 400, at least about 85 vol % of the total volume of the porous ceramic particle 400, at least about 90 vol % of the total volume of the porous ceramic particle 400, at least about 95 vol % of the total volume of the porous ceramic particle 400 or even at least about 99 vol % of the total volume of the porous ceramic particle 400. According to still other embodiments, the layered region may make up not greater than about 99.5 vol % of the total volume of the porous ceramic particle 400, such as, not greater than about 99 vol % of the total volume of the porous ceramic particle 400, not greater than about 95 vol % of the total volume of the porous ceramic particle 400, not greater than about 90 vol % of the total volume of the porous ceramic particle 400, not greater than about 85 vol % of the total volume of the porous ceramic particle 400, not greater than about 80 vol % of the total volume of the porous ceramic particle 400, not greater than about 75 vol % of the total volume of the porous ceramic particle 400, not greater than about 70 vol % of the total volume of the porous ceramic particle 400, not greater than about 65 vol % of the total volume of the porous ceramic particle 400, not greater than about 60 vol % of the total volume of the porous ceramic particle 400 or even not greater than about 55 vol % of the total volume of the porous ceramic particle 400. It will be appreciated that the layered region 420 may make up any volume percentage of the total volume of the porous ceramic particle 400 between any of the minimum and maximum values noted above. It will be further appreciated that the layered region 420 may make up any volume percentage of the total volume of the porous ceramic particle 400 within a range between any of the minimum and maximum values noted above.

According to certain embodiments, the core region 410 may be the same as the layered region 420. According to still other embodiments, the core region 410 may have the same composition as the layered region 420. According to particular embodiments, the core region 410 and the layered region 420 may be formed of the same material. According to yet other embodiments, the core region 410 may have the same microstructure as the layered region 420. According to yet other embodiments, the core region 410 may have the same particle density as the layered region 420, where the particle density is the particle mass divided by the particle volume including intraparticle porosity. According to yet other embodiments, the core region 410 may have the same porosity as the layered region 420.

According to certain embodiments, the core region 410 may be different than the layered region 420. According to still other embodiments, the core region 410 may have different composition than the layered region 420. According to particular embodiments, the core region 410 and the layered region 420 may be formed of different materials. According to yet other embodiments, the core region 410 may have a different microstructure than the layered region 420. According to yet other embodiments, the core region 410 may have a different particle density than the layered region 420, where the particle density is the particle mass divided by the particle volume including intraparticle porosity. According to yet other embodiments, the core region 410 may have a different porosity than the layered region 420.

According to yet another particular embodiment, the core region 410 may include a first alumina phase and the layered region may include a second alumina phase. According to still other embodiments, the first alumina phase and the second alumina phase may be the same. According to still other embodiments, the first alumina phase and the second alumina phase may be distinct. According to yet other embodiments, the first alumina phase may be an alpha alumina and the second alumina phases may be a non-alpha alumina phase.

According to certain embodiments, the layered region composition may be the same as the core region composition. It will be appreciated that when the layered region composition is referred to as being the same as the core region composition, the layered region composition includes the same materials at the same relative concentrations as the core region composition.

According to still other embodiments, the layered region composition may be different than the core region composition. It will be appreciated that when the layered region composition is referred to as being different than the core region composition, the layered region composition includes different materials than the core region composition, different relative concentrations of materials than the core region composition or both different materials and different relative concentrations of materials than the core region composition.

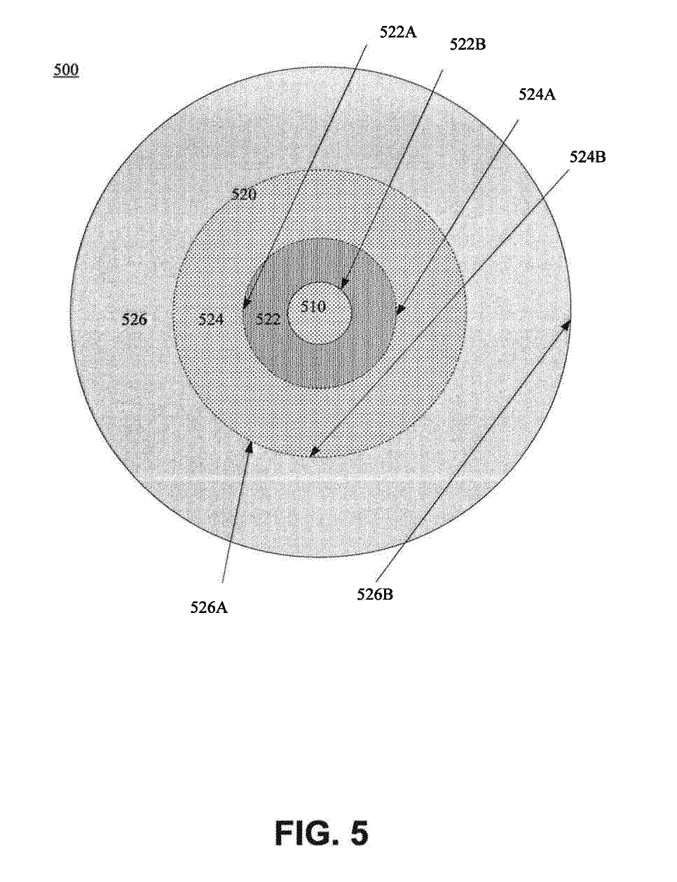

Referring to yet other embodiments of the plurality of porous ceramic particles formed according to embodiments described herein, a plurality of porous ceramic particles may each be described as including a particular cross-section having a core region and a layered region overlying the core region where the layered region includes multiple distinct layered sections. By way of illustration, FIG. 5 shows a cross-sectional image of an embodiment of a porous ceramic particle formed according to embodiments described herein having a layered region having distinct layered sections. As shown in FIG. 5, a porous ceramic particle 500 may include a core region 510 and a layered region 520 overlying the core region 510. The layered region 520 may further include distinct layered sections 522, 524 and 526.

It will be appreciated that the core region 510 and the layered region 520 may include any of the characteristics described in reference to corresponding components shown in FIG. 4 (i.e., core region 410 and layered region 410).

It will be appreciated that, according to certain embodiments, the core region 510 may be referred to as a seed or initial particle. According to still other embodiments, the core region 510 may be monolithic. According to still other embodiments, the core region 510 may include a core region composition. According to yet other embodiments, the core region composition may include a particular material or a combination of particular materials. According to still other embodiments, the material or materials included in the core region composition may include a ceramic material. According to still other embodiments, the core region of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the core region composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to still other embodiments, a first layered section 522 may include overlapping layers surrounding the core region 510 as shown in FIG. 5.

According to still other embodiments, the first layered section 522 may have a particular porosity. For example, the first layered section 522 may have an average porosity of at least about 0.01 cc/g, such as, at least about 0.05 cc/g, at least about 0.10 cc/g, at least about 0.25 cc/g, at least about 0.50 cc/g, at least about 0.75 cc/g, at least about 1.00 cc/g, at least about 1.10 cc/g, at least about 1.20 cc/g, at least about 1.30 cc/g, at least about 1.40 cc/g, at least about 1.50 cc/g or even at least about 1.55 cc/g. According to still other embodiments, the first layered section 522 may have an average porosity of not greater than about 1.60 cc/g, such as, not greater than about 1.55 cc/g, not greater than about 1.50 cc/g, not greater than about 1.45 cc/g, not greater than about 1.40 cc/g, not greater than about 1.35 cc/g, not greater than about 1.30 cc/g, not greater than about 1.25 cc/g, not greater than about 1.20 cc/g, not greater than about 1.15 cc/g, not greater than about 1.10 cc/g, not greater than about 1.05 cc/g, not greater than about 1.00 cc/g, not greater than about 0.95 cc/g, not greater than about 0.90 cc/g or even not greater than about 0.85 cc/g. It will be appreciated that the layered region may have a porosity of any value between any of the minimum and maximum values noted above. It will be further appreciated that the layered region may have a porosity of any value within a range between any of the minimum and maximum values noted above.

According to other embodiments, the first layered section 522 may make up a particular volume percentage of the total volume of the porous ceramic particle 500. For example, the first layered section 522 may make up at least about 50 vol % of the total volume of the porous ceramic particle 500, such as, at least about 55 vol % of the total volume of the porous ceramic particle 500, at least about 60 vol % of the total volume of the porous ceramic particle 500, at least about 65 vol % of the total volume of the porous ceramic particle 500, at least about 70 vol % of the total volume of the porous ceramic particle 500, at least about 75 vol % of the total volume of the porous ceramic particle 500, at least about 80 vol % of the total volume of the porous ceramic particle 500, at least about 85 vol % of the total volume of the porous ceramic particle 500, at least about 90 vol % of the total volume of the porous ceramic particle 500, at least about 95 vol % of the total volume of the porous ceramic particle 500 or even at least about 99 vol % of the total volume of the porous ceramic particle 500. According to still other embodiments, the layered region may make up not greater than about 99.5 vol % of the total volume of the porous ceramic particle 500, such as, not greater than about 99 vol % of the total volume of the porous ceramic particle 500, not greater than about 95 vol % of the total volume of the porous ceramic particle 500, not greater than about 90 vol % of the total volume of the porous ceramic particle 500, not greater than about 85 vol % of the total volume of the porous ceramic particle 500, not greater than about 80 vol % of the total volume of the porous ceramic particle 500, not greater than about 75 vol % of the total volume of the porous ceramic particle 500, not greater than about 70 vol % of the total volume of the porous ceramic particle 500, not greater than about 65 vol % of the total volume of the porous ceramic particle 500, not greater than about 60 vol % of the total volume of the porous ceramic particle 500 or even not greater than about 55 vol % of the total volume of the porous ceramic particle 500. It will be appreciated that the first layered section 522 may make up any volume percentage of the total volume of the porous ceramic particle 500 between any of the minimum and maximum values noted above. It will be further appreciated that the first layered section 522 may make up any volume percentage of the total volume of the porous ceramic particle 500 within a range between any of the minimum and maximum values noted above.

According to certain embodiments, the core region 510 may be the same as the first layered section 522. According to still other embodiments, the core region 510 may have the same composition as the first layered section 522. According to particular embodiments, the core region 510 and the first layered section 522 may be formed of the same material. According to yet other embodiments, the core region 510 may have the same microstructure as the first layered section 522. According to yet other embodiments, the core region 510 may have the same particle density as the first layered section 522, where the particle density is the particle mass divided by the particle volume including intraparticle porosity. According to yet other embodiments, the core region 510 may have the same porosity as the first layered section 522.

According to certain embodiments, the core region 510 may be different than the first layered section 522. According to still other embodiments, the core region 510 may have different composition than the first layered section 522. According to particular embodiments, the core region 510 and the first layered section 522 may be formed of different materials. According to yet other embodiments, the core region 510 may have a different microstructure than the first layered section 522. According to yet other embodiments, the core region 510 may have a different particle density than the first layered section 522, where the particle density is the particle mass divided by the particle volume including intraparticle porosity. According to yet other embodiments, the core region 510 may have a different porosity than the first layered section 522.

According to certain embodiments, the first layered section 522 may include a first layered section composition. According to yet other embodiments, the first layered section composition may include a particular material or a combination of particular materials. According to still other embodiments, the material or materials included in the first layered section composition may include a ceramic material. According to still other embodiments, the first layered section of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the first layered section composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to certain embodiments, the first layered section composition may be the same as the core region composition. It will be appreciated that when the first layered section composition is referred to as being the same as the core region composition, the first layered section composition includes the same materials at the same relative concentrations as the core region composition.

According to still other embodiments, the first layered section composition may be different than the core region composition. It will be appreciated that when the first layered section composition is referred to as being different than the core region composition, the first layered section composition includes different materials than the core region composition, different relative concentrations of materials than the core region composition or both different materials and different relative concentrations of materials than the core region composition.

According to yet other embodiments, the first layered section 522 may be defined as having an inner surface 522A and an outer surface 522B. The inner surface 522A of the first layered section 522 is defined as the surface closest to the core region 510. The outer surface 522B of the first layered section 522 is defined as the surface farthest from the core region 510.

According to certain embodiments, first layered section 522 may have a uniform or homogeneous first layered section composition throughout a thickness of the first layered section 522 from the inner surface 522A to the outer surface 522B of the first layered section 522. It will be appreciated that as described herein, a uniform or homogeneous first layered section composition is defined as having less than a 1 percent variation in the concentrations of any material or materials within the first layered section composition throughout a thickness of the first layered section 522 from the inner surface 522A to the outer surface 522B of the first layered section 522.

It will also be appreciated that the concentration of a particular material within a formed porous ceramic particle or catalyst carrier or within a particular portion of a formed porous ceramic particle or catalyst carrier as described herein refers to the elemental composition of that material. The elemental composition is determined on mounted and polished samples using a Hitachi S-4300 Field Emission Scanning Electron Microscope with an Oxford Instruments EDS X-Max 150 detector and the Oxford Aztec software (version 3.1). A representative sample of the material is first mounted in a two-part epoxy resin, such as Struers Epofix. Once the epoxy has completely cured, the specimen is ground and polished. For example, the specimen can be mounted on a Struers Tegramin-30 grinder/polisher. The specimen is then ground and polished using a multi-step process with increasingly fine pads and abrasives. A typical sequence would be an MD-Piano 80 grinding disk at 300 rpm for nominally 1.5 minutes (till the specimen is exposed from the epoxy), an MP-Piano 220 at 300 rpm for 1.5 minutes, an MD-Piano 1200 at 300 rpm for 2 minutes, an MD-Largo polishing disk with DiaPro Allegro/Largo diamond abrasive at 150 rpm for 5 minutes, and finally an MD-Dur pad with DiaPro Dur at 150 rpm for 4 minutes. All of this is done with deionized water as the lubricant. After polishing, the polished surface of the sample is carbon-coated using, for example, a SPI Carbon Coater. The sample is placed on the stage of the coater 5.5 cm from the carbon fiber. A new carbon fiber is cut and secured into the coating head. The chamber is closed and evacuated. The coater is run at 3 volts for 20 seconds to clean the fiber surface. It is then run at 7 volts in pulse mode until the fiber stops glowing. The sample is then ready to be placed on an appropriate microscope mount and inserted into the microscope. The specimen is first examined in the SEM using the Backscatter mode. Typical conditions are a working distance of 15 mm, 15 kV acceleration voltage, and magnifications from ×25 to ×200. The specimen is examined to find spheres that have been appropriately sectioned so as to show their entire cross-section. Once appropriate sites are found, further examination is conducted with the Aztec software. In the Aztec software, the detector is first cooled to operating conditions using the “Control of the EDS detector EDS1” function. Once the detector is cool, “Point & ID” is selected, as well as the “Guided” mode. The “Linescan” option is selected and an electron image of the area of interest is obtained. One may look at the elemental composition in either Line Scan (one dimensional) or Mapping (two dimensional) mode. While in the Linescan mode, select the “Acquire Line Data” window. Using the line drawing tools, select the appropriate section for the scan (such as a diagonal across the middle of the sphere). Click “Start” to begin acquiring data. The software will automatically identify the chemical elements it finds. One can also manually select elements for inclusion or exclusion. For the two-dimensional mapping, select “Map” from the options, and then the “Acquire Map Data” window. You can either map the entire visible image or a selected region. As with the line scan, the software will automatically identify the chemical elements it finds or one can also manually select elements for inclusion or exclusion.

According to still other embodiments, first layered section 522 may have a varying first layered section composition throughout a thickness of the first layered section 522 from the inner surface 522A to the outer surface 522B of the first layered section 522. According to still other embodiments, first layered section 522 may have a varying first layered section composition described as a gradual concentration gradient composition throughout a portion or a the entire thickness of the first layered section 522 from the inner surface 522A to the outer surface 522B of the first layered section 522. It will be appreciated that as described herein, a gradual concentration gradient composition may be defined as a gradual change from a first concentration of a particular material in the first layered section composition as measured at the inner surface 522A of the first layered section 522 to a second concentration of the same particular material in the first layered section composition as measured at the outer surface 522B of the first layered section 522. According to certain embodiments, the particular material may be a ceramic material within the first layered section composition. According to yet other embodiments, the ceramic material may be any desired ceramic material suitable for forming porous ceramic particles, such as, for example, alumina, zirconia, titania, silica or a combination thereof. According to still other embodiments, the first layered section composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to still other embodiments, the gradual concentration gradient composition may be an increasing gradual concentration gradient composition where the first concentration of a particular material as measured at the inner surface 522A of the first layered section 522 is less than the second concentration of the same particular material as measured at the outer surface 522B of the first layered section 522. According to yet other embodiments, the gradual concentration gradient composition may be a decreasing gradual concentration gradient composition where the first concentration of a particular material as measured at the inner surface 522A of the first layered section 522 is greater than the second concentration of the same particular material as measured at the outer surface 522B of the first layered section 522.

According to still other embodiments, a second layered section 524 may include overlapping layers surrounding the core region 510 and the first layered section 522 as shown in FIG. 5.

According to still other embodiments, the second layered section 524 may have a particular porosity. For example, the second layered section 524 may have an average porosity of at least about 0.01 cc/g, such as, at least about 0.05 cc/g, at least about 0.10 cc/g, at least about 0.25 cc/g, at least about 0.50 cc/g, at least about 0.75 cc/g, at least about 1.00 cc/g, at least about 1.10 cc/g, at least about 1.20 cc/g, at least about 1.30 cc/g, at least about 1.40 cc/g, at least about 1.50 cc/g or even at least about 1.55 cc/g. According to still other embodiments, the second layered section 524 may have an average porosity of not greater than about 1.60 cc/g, such as, not greater than about 1.55 cc/g, not greater than about 1.50 cc/g, not greater than about 1.45 cc/g, not greater than about 1.40 cc/g, not greater than about 1.35 cc/g, not greater than about 1.30 cc/g, not greater than about 1.25 cc/g, not greater than about 1.20 cc/g, not greater than about 1.15 cc/g, not greater than about 1.10 cc/g, not greater than about 1.05 cc/g, not greater than about 1.00 cc/g, not greater than about 0.95 cc/g, not greater than about 0.90 cc/g or even not greater than about 0.85 cc/g. It will be appreciated that the layered region may have a porosity of any value between any of the minimum and maximum values noted above. It will be further appreciated that the layered region may have a porosity of any value within a range between any of the minimum and maximum values noted above.

According to other embodiments, the second layered section 524 may make up a particular volume percentage of the total volume of the porous ceramic particle 500. For example, the second layered section 524 may make up at least about 50 vol % of the total volume of the porous ceramic particle 500, such as, at least about 55 vol % of the total volume of the porous ceramic particle 500, at least about 60 vol % of the total volume of the porous ceramic particle 500, at least about 65 vol % of the total volume of the porous ceramic particle 500, at least about 70 vol % of the total volume of the porous ceramic particle 500, at least about 75 vol % of the total volume of the porous ceramic particle 500, at least about 80 vol % of the total volume of the porous ceramic particle 500, at least about 85 vol % of the total volume of the porous ceramic particle 500, at least about 90 vol % of the total volume of the porous ceramic particle 500, at least about 95 vol % of the total volume of the porous ceramic particle 500 or even at least about 99 vol % of the total volume of the porous ceramic particle 500. According to still other embodiments, the layered region may make up not greater than about 99.5 vol % of the total volume of the porous ceramic particle 500, such as, not greater than about 99 vol % of the total volume of the porous ceramic particle 500, not greater than about 95 vol % of the total volume of the porous ceramic particle 500, not greater than about 90 vol % of the total volume of the porous ceramic particle 500, not greater than about 85 vol % of the total volume of the porous ceramic particle 500, not greater than about 80 vol % of the total volume of the porous ceramic particle 500, not greater than about 75 vol % of the total volume of the porous ceramic particle 500, not greater than about 70 vol % of the total volume of the porous ceramic particle 500, not greater than about 65 vol % of the total volume of the porous ceramic particle 500, not greater than about 60 vol % of the total volume of the porous ceramic particle 500 or even not greater than about 55 vol % of the total volume of the porous ceramic particle 500. It will be appreciated that the second layered section 524 may make up any volume percentage of the total volume of the porous ceramic particle 500 between any of the minimum and maximum values noted above. It will be further appreciated that the second layered section 524 may make up any volume percentage of the total volume of the porous ceramic particle 500 within a range between any of the minimum and maximum values noted above.

According to certain embodiments, the core region 510 may be the same as the second layered section 524. According to still other embodiments, the core region 510 may have the same composition as the second layered section 524. According to particular embodiments, the core region 510 and the second layered section 524 may be formed of the same material. According to yet other embodiments, the core region 510 may have the same microstructure as the second layered section 524. According to yet other embodiments, the core region 510 may have the same particle density as the second layered section 524, where the particle density is the particle mass divided by the particle volume including intraparticle porosity. According to yet other embodiments, the core region 510 may have the same porosity as the second layered section 524.

According to certain embodiments, the first layered section 522 may be the same as the second layered section 524. According to still other embodiments, the first layered section 522 may have the same composition as the second layered section 524. According to particular embodiments, the first layered section 522 and the second layered section 524 may be formed of the same material. According to yet other embodiments, the first layered section 522 may have the same microstructure as the second layered section 524. According to yet other embodiments, the first layered section 522 may have the same particle density as the second layered section 524, where the particle density is the particle mass divided by the particle volume including intraparticle porosity. According to yet other embodiments, the first layered section 522 may have the same porosity as the second layered section 524.

According to certain embodiments, the core region 510 may be different than the second layered section 524. According to still other embodiments, the core region 510 may have different composition than the second layered section 524. According to particular embodiments, the core region 510 and the second layered section 524 may be formed of different materials. According to yet other embodiments, the core region 510 may have a different microstructure than the second layered section 524. According to yet other embodiments, the core region 510 may have a different particle density than the second layered section 524, where the particle density is the particle mass divided by the particle volume including intraparticle porosity. According to yet other embodiments, the core region 510 may have a different porosity than the second layered section 524.

According to certain embodiments, the first layered section 522 may be different than the second layered section 524. According to still other embodiments, the first layered section 522 may have different composition than the second layered section 524. According to particular embodiments, the first layered section 522 and the second layered section 524 may be formed of different materials. According to yet other embodiments, the first layered section 522 may have a different microstructure than the second layered section 524. According to yet other embodiments, the first layered section 522 may have a different particle density than the second layered section 524, where the particle density is the particle mass divided by the particle volume including intraparticle porosity. According to yet other embodiments, the first layered section 522 may have a different porosity than the second layered section 524.

According to certain embodiments, the second layered section 524 may include a second layered section composition. According to yet other embodiments, the second layered section composition may include a particular material or a combination of particular materials. According to still other embodiments, the material or materials included in the second layered section composition may include a ceramic material. According to still other embodiments, the first layered section of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the second layered section composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to certain embodiments, the second layered section composition may be the same as the core region composition. It will be appreciated that when the second layered section composition is referred to as being the same as the core region composition, the second layered section composition includes the same materials at the same relative concentrations as the core region composition.

According to other embodiments, the second layered section composition may be the same as the first layered section composition. It will be appreciated that when the second layered section composition is referred to as being the same as the first layered section composition, the second layered section composition includes the same materials at the same relative concentrations as the first layered section composition.

According to still other embodiments, the second layered section composition may be different than the core region composition. It will be appreciated that when the second layered section composition is referred to as being different than the core region composition, the second layered section composition includes different materials than the core region composition, different relative concentrations of materials than the core region composition or both different materials and different relative concentrations of materials than the core region composition.

According to still other embodiments, the second layered section composition may be different than the first layered section composition. It will be appreciated that when the second layered section composition is referred to as being different than the first layered section composition, the second layered section composition includes different materials than the first layered section composition, different relative concentrations of materials than the first layered section composition or both different materials and different relative concentrations of materials than the first layered section composition.

According to yet other embodiments, the second layered section 524 may be defined as having an inner surface 524A and an outer surface 524B. The inner surface 524A of the second layered section 524 is defined as the surface closest to the first layered section 522. The outer surface 524B of the second layered section 524 is defined as the surface farthest from the first layered section 522.

According to certain embodiments, second layered section 524 may have a uniform or homogeneous second layered section composition throughout a thickness of the second layered section 524 from the inner surface 524A to the outer surface 524B of the second layered section 524. It will be appreciated that as described herein, a uniform or homogeneous first layered section composition is defined as having less than a 1 percent variation in the concentrations of any material or materials within the first layered section composition throughout a thickness of the first layered section 524 from the inner surface 524A to the outer surface 524B of the first layered section 524.

According to still other embodiments, second layered section 524 may have a varying second layered section composition throughout a thickness of the second layered section 524 from the inner surface 524A to the outer surface 524B of the second layered section 524. According to still other embodiments, second layered section 524 may have a varying second layered section composition described as a gradual concentration gradient composition throughout a portion or a the entire thickness of the second layered section 524 from the inner surface 524A to the outer surface 524B of the second layered section 524. It will be appreciated that as described herein, a gradual concentration gradient composition may be defined as a gradual change from a first concentration of a particular material in the second layered section composition as measured at the inner surface 524A of the second layered section 524 to a second concentration of the same particular material in the second layered section composition as measured at the outer surface 524B of the second layered section 524. According to certain embodiments, the particular material may be a ceramic material within the second layered section composition. According to yet other embodiments, the ceramic material may be any desired ceramic material suitable for forming porous ceramic particles, such as, for example, alumina, zirconia, titania, silica or a combination thereof. According to still other embodiments, the second layered section composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to still other embodiments, the gradual concentration gradient composition may be an increasing gradual concentration gradient composition where the first concentration of a particular material as measured at the inner surface 524A of the second layered section 524 is less than the second concentration of the same particular material as measured at the outer surface 524B of the second layered section 524. According to yet other embodiments, the gradual concentration gradient composition may be a decreasing gradual concentration gradient composition where the first concentration of a particular material as measured at the inner surface 524A of the second layered section 524 is greater than the second concentration of the same particular material as measured at the outer surface 524B of the second layered section 524

According to still other embodiments, a third layer section 526 may include overlapping layers surrounding the core region 510, the first layered section 522 and the second layered section 524 as shown in FIG. 5.

According to still other embodiments, the third layer section 526 may have a particular porosity. For example, the third layer section 526 may have an average porosity of at least about 0.01 cc/g, such as, at least about 0.05 cc/g, at least about 0.10 cc/g, at least about 0.25 cc/g, at least about 0.50 cc/g, at least about 0.75 cc/g, at least about 1.00 cc/g, at least about 1.10 cc/g, at least about 1.20 cc/g, at least about 1.30 cc/g, at least about 1.40 cc/g, at least about 1.50 cc/g or even at least about 1.55 cc/g. According to still other embodiments, the third layer section 526 may have an average porosity of not greater than about 1.60 cc/g, such as, not greater than about 1.55 cc/g, not greater than about 1.50 cc/g, not greater than about 1.45 cc/g, not greater than about 1.40 cc/g, not greater than about 1.35 cc/g, not greater than about 1.30 cc/g, not greater than about 1.25 cc/g, not greater than about 1.20 cc/g, not greater than about 1.15 cc/g, not greater than about 1.10 cc/g, not greater than about 1.05 cc/g, not greater than about 1.00 cc/g, not greater than about 0.95 cc/g, not greater than about 0.90 cc/g or even not greater than about 0.85 cc/g. It will be appreciated that the layered region may have a porosity of any value between any of the minimum and maximum values noted above. It will be further appreciated that the layered region may have a porosity of any value within a range between any of the minimum and maximum values noted above.

According to other embodiments, the third layer section 526 may make up a particular volume percentage of the total volume of the porous ceramic particle 500. For example, the third layer section 526 may make up at least about 50 vol % of the total volume of the porous ceramic particle 500, such as, at least about 55 vol % of the total volume of the porous ceramic particle 500, at least about 60 vol % of the total volume of the porous ceramic particle 500, at least about 65 vol % of the total volume of the porous ceramic particle 500, at least about 70 vol % of the total volume of the porous ceramic particle 500, at least about 75 vol % of the total volume of the porous ceramic particle 500, at least about 80 vol % of the total volume of the porous ceramic particle 500, at least about 85 vol % of the total volume of the porous ceramic particle 500, at least about 90 vol % of the total volume of the porous ceramic particle 500, at least about 95 vol % of the total volume of the porous ceramic particle 500 or even at least about 99 vol % of the total volume of the porous ceramic particle 500. According to still other embodiments, the layered region may make up not greater than about 99.5 vol % of the total volume of the porous ceramic particle 500, such as, not greater than about 99 vol % of the total volume of the porous ceramic particle 500, not greater than about 95 vol % of the total volume of the porous ceramic particle 500, not greater than about 90 vol % of the total volume of the porous ceramic particle 500, not greater than about 85 vol % of the total volume of the porous ceramic particle 500, not greater than about 80 vol % of the total volume of the porous ceramic particle 500), not greater than about 75 vol % of the total volume of the porous ceramic particle 500, not greater than about 70 vol % of the total volume of the porous ceramic particle 500, not greater than about 65 vol % of the total volume of the porous ceramic particle 500, not greater than about 60 vol % of the total volume of the porous ceramic particle 500 or even not greater than about 55 vol % of the total volume of the porous ceramic particle 500. It will be appreciated that the third layer section 526 may make up any volume percentage of the total volume of the porous ceramic particle 500 between any of the minimum and maximum values noted above. It will be further appreciated that the third layer section 526 may make up any volume percentage of the total volume of the porous ceramic particle 500 within a range between any of the minimum and maximum values noted above.

According to certain embodiments, the core region 510 may be the same as the third layered section 526. According to still other embodiments, the core region 510 may have the same composition as the third layered section 526. According to particular embodiments, the core region 510 and the third layered section 526 may be formed of the same material. According to yet other embodiments, the core region 510 may have the same microstructure as the third layered section 526. According to yet other embodiments, the core region 510 may have the same particle density as the third layered section 526, where the particle density is the particle mass divided by the particle volume including intraparticle porosity. According to yet other embodiments, the core region 510 may have the same porosity as the third layered section 526.

According to certain embodiments, the first layered section 522 may be the same as the third layered section 526. According to still other embodiments, the first layered section 522 may have the same composition as the third layered section 526. According to particular embodiments, the first layered section 522 and the third layered section 526 may be formed of the same material. According to yet other embodiments, the first layered section 522 may have the same microstructure as the third layered section 526. According to yet other embodiments, the first layered section 522 may have the same particle density as the third layered section 526, where the particle density is the particle mass divided by the particle volume including intraparticle porosity. According to yet other embodiments, the first layered section 522 may have the same porosity as the third layered section 526.

According to certain embodiments, the second layered section 524 may be the same as the third layered section 526. According to still other embodiments, the second layered section 524 may have the same composition as the third layered section 526. According to particular embodiments, the second layered section 524 and the third layered section 526 may be formed of the same material. According to yet other embodiments, the second layered section 524 may have the same microstructure as the third layered section 526. According to yet other embodiments, the second layered section 524 may have the same particle density as the third layered section 526, where the particle density is the particle mass divided by the particle volume including intraparticle porosity. According to yet other embodiments, the second layered section 524 may have the same porosity as the third layered section 526.

According to certain embodiments, the core region 510 may be different than the third layered section 526. According to still other embodiments, the core region 510 may have different composition than the third layered section 526. According to particular embodiments, the core region 510 and the third layered section 526 may be formed of different materials. According to yet other embodiments, the core region 510 may have a different microstructure than the third layered section 526. According to yet other embodiments, the core region 510 may have a different particle density than the third layered section 526, where the particle density is the particle mass divided by the particle volume including intraparticle porosity. According to yet other embodiments, the core region 510 may have a different porosity than the third layered section 526.

According to certain embodiments, the first layered section 522 may be different than the third layered section 526. According to still other embodiments, the first layered section 522 may have different composition than the third layered section 526. According to particular embodiments, the first layered section 522 and the third layered section 526 may be formed of different materials. According to yet other embodiments, the first layered section 522 may have a different microstructure than the third layered section 526. According to yet other embodiments, the first layered section 522 may have a different particle density than the third layered section 526, where the particle density is the particle mass divided by the particle volume including intraparticle porosity. According to yet other embodiments, the first layered section 522 may have a different porosity than the third layered section 526.

According to certain embodiments, the second layered section 524 may be different than the third layered section 526. According to still other embodiments, the second layered section 524 may have different composition than the third layered section 526. According to particular embodiments, the second layered section 524 and the third layered section 526 may be formed of different materials. According to yet other embodiments, the second layered section 524 may have a different microstructure than the third layered section 526. According to yet other embodiments, the second layered section 524 may have a different particle density than the third layered section 526, where the particle density is the particle mass divided by the particle volume including intraparticle porosity. According to yet other embodiments, the second layered section 524 may have a different porosity than the third layered section 526.

According to certain embodiments, the third layer section 526 may include a third layered section composition. According to yet other embodiments, the third layered section composition may include a particular material or a combination of particular materials. According to still other embodiments, the material or materials included in the third layered section composition may include a ceramic material. According to still other embodiments, the third layered section of each ceramic particle may consist essentially of a ceramic material. It will be appreciated that the ceramic material may be any desired ceramic material suitable for forming porous ceramic particles, such as, for example, alumina, zirconia, titania, silica or a combination thereof. According to still other embodiments, the third layered section composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to certain embodiments, the third layered section composition may be the same as the core region composition. It will be appreciated that when the third layered section composition is referred to as being the same as the core region composition, the third layered section composition includes the same materials at the same relative concentrations as the core region composition.

According to other embodiments, the third layered section composition may be the same as the first layered section composition. It will be appreciated that when the third layered section composition is referred to as being the same as the first layered section composition, the third layered section composition includes the same materials at the same relative concentrations as the first layered section composition.

According to other embodiments, the third layered section composition may be the same as the second layered section composition. It will be appreciated that when the third layered section composition is referred to as being the same as the second layered section composition, the third layered section composition includes the same materials at the same relative concentrations as the second layered section composition.

According to still other embodiments, the third layered section composition may be different than the core region composition. It will be appreciated that when the third layered section composition is referred to as being different than the core region composition, the third layered section composition includes different materials than the core region composition, different relative concentrations of materials than the core region composition or both different materials and different relative concentrations of materials than the core region composition.

According to still other embodiments, the third layered section composition may be different than the first layered section composition. It will be appreciated that when the third layered section composition is referred to as being different than the first layered section composition, the third layered section composition includes different materials than the first layered section composition, different relative concentrations of materials than the first layered section composition or both different materials and different relative concentrations of materials than the first layered section composition.

According to still other embodiments, the third layered section composition may be different than the second layered section composition. It will be appreciated that when the third layered section composition is referred to as being different than the second layered section composition, the third layered section composition includes different materials than the second layered section composition, different relative concentrations of materials than the second layered section composition or both different materials and different relative concentrations of materials than the second layered section composition.

According to yet other embodiments, the third layer section 526 may be defined as having an inner surface 526A and an outer surface 526B. The inner surface 526A of the third layer section 526 is defined as the surface closest to the second layered section 524. The outer surface 526B of the third layer section 526 is defined as the surface farthest from the second layered section 524.

According to certain embodiments, third layer section 526 may have a uniform or homogeneous third layered section composition throughout a thickness of the third layer section 526 from the inner surface 526A to the outer surface 526B of the third layer section 526. It will be appreciated that as described herein, a uniform or homogeneous first layered section composition is defined as having less than a 1 percent variation in the concentrations of any material or materials within the first layered section composition throughout a thickness of the first layered section 526 from the inner surface 526A to the outer surface 526B of the first layered section 526.

According to still other embodiments, third layer section 526 may have a varying third layered section composition throughout a thickness of the third layer section 526 from the inner surface 526A to the outer surface 526B of the third layer section 526. According to still other embodiments, third layer section 526 may have a varying third layered section composition described as a gradual concentration gradient composition throughout a portion or a the entire thickness of the third layer section 526 from the inner surface 526A to the outer surface 526B of the third layer section 526. It will be appreciated that as described herein, a gradual concentration gradient composition may be defined as a gradual change from a first concentration of a particular material in the third layered section composition as measured at the inner surface 526A of the third layer section 526 to a second concentration of the same particular material in the third layered section composition as measured at the outer surface 526B of the third layer section 526. According to certain embodiments, the particular material may be a ceramic material within the third layered section composition. According to yet other embodiments, the ceramic material may be any desired ceramic material suitable for forming porous ceramic particles, such as, for example, alumina, zirconia, titania, silica or a combination thereof. According to still other embodiments, the third layered section composition may include any one of lanthanum (La), zinc (Zn), nickel (Ni), cobalt (Co), niobium (Nb), tungsten (W), magnesium (Mg), calcium (Ca), strontium (Sr), barium (Ba), bismuth (Bi) or combinations thereof.

According to still other embodiments, the gradual concentration gradient composition may be an increasing gradual concentration gradient composition where the first concentration of a particular material as measured at the inner surface 526A of the third layer section 526 is less than the second concentration of the same particular material as measured at the outer surface 526B of the third layer section 526. According to yet other embodiments, the gradual concentration gradient composition may be a decreasing gradual concentration gradient composition where the first concentration of a particular material as measured at the inner surface 526A of the third layer section 526 is greater than the second concentration of the same particular material as measured at the outer surface 526B of the third layer section 526.

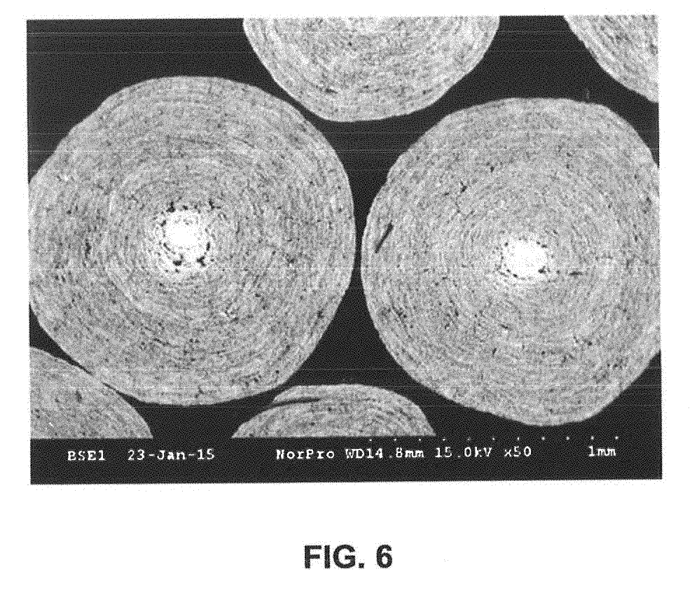

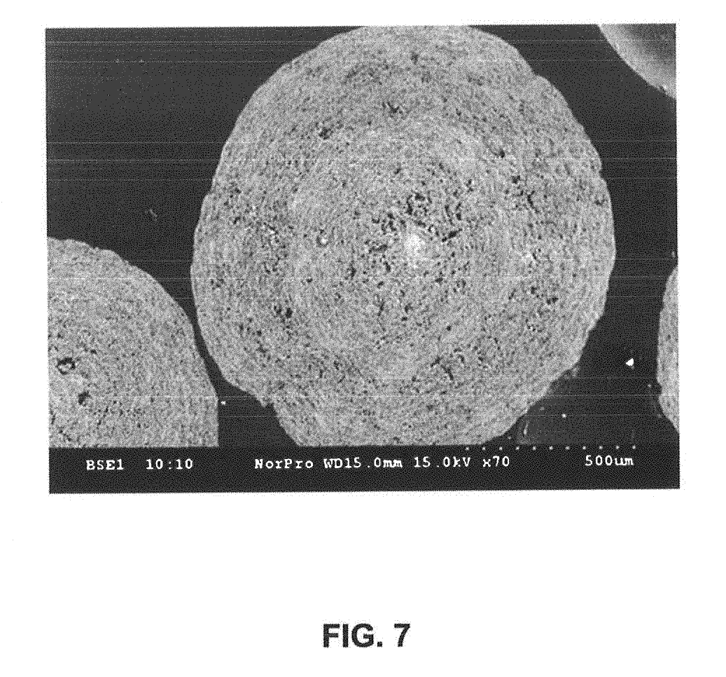

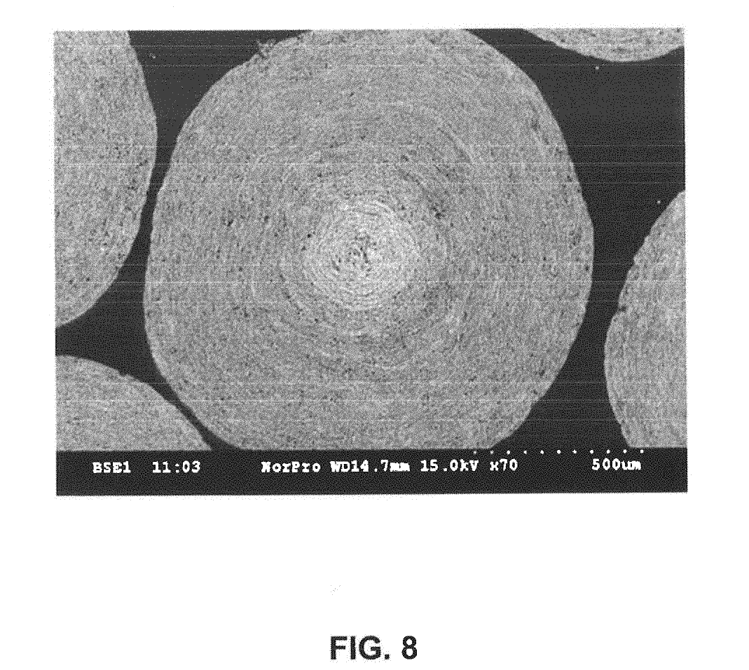

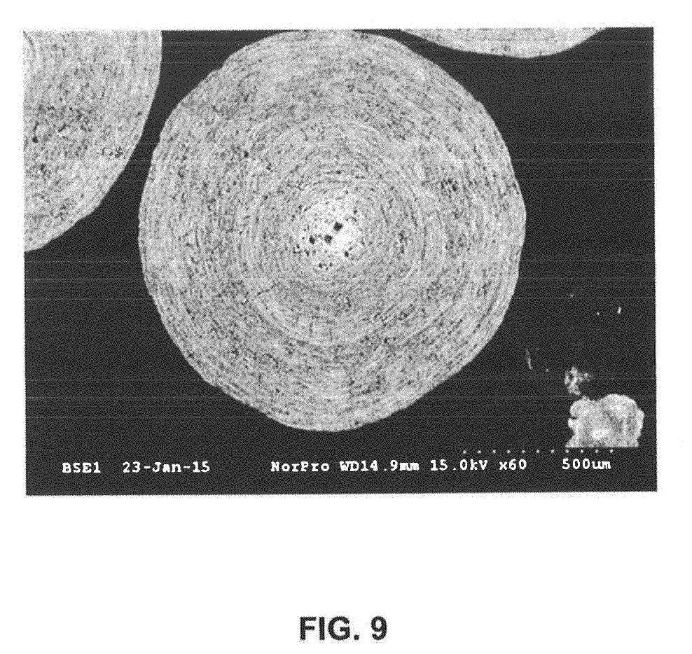

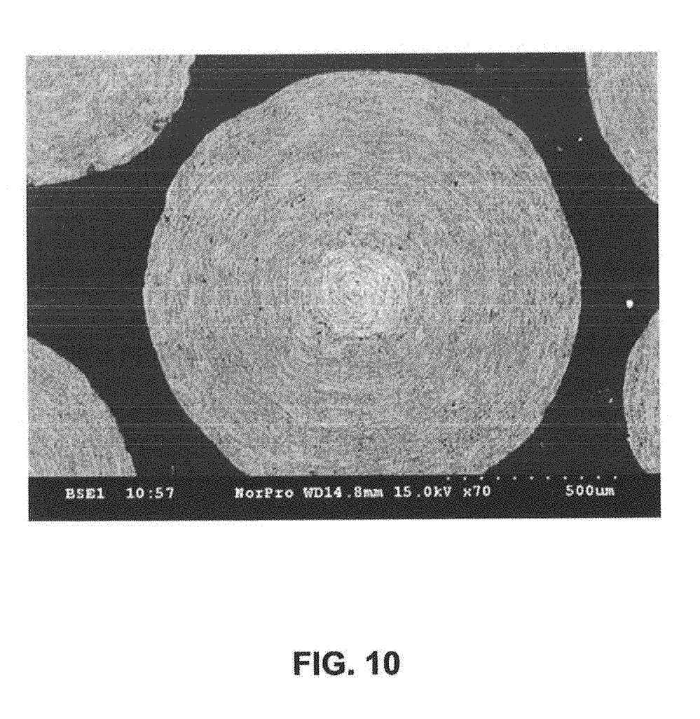

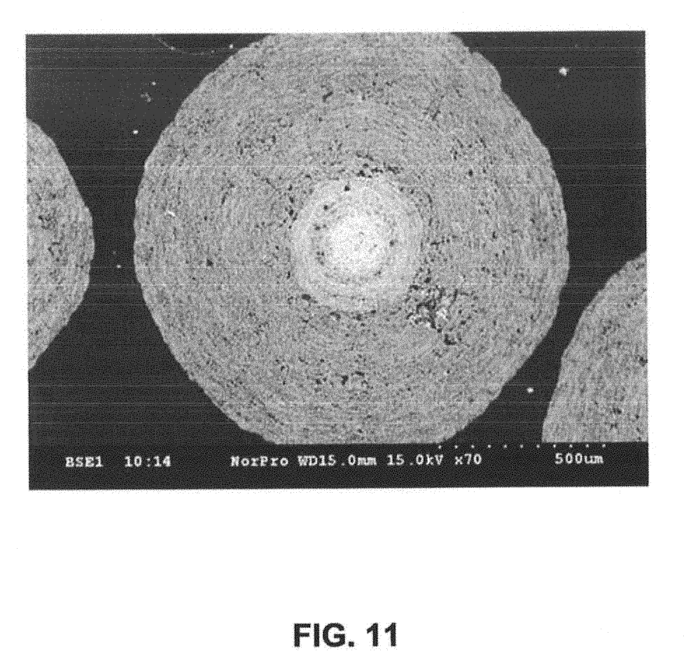

For purposes of illustration, FIGS. 6-11 include cross-sectional images of porous ceramic particles formed according to embodiments described herein.

According to still another particular embodiment, the porous ceramic particles described herein may be formed as a catalyst carrier or a component of a catalyst carrier. It will be appreciated that where the porous ceramic particles described herein are formed as a catalyst carrier or a component of a catalyst carrier, the catalyst carrier may be described as having any of the characteristics described herein with reference to a porous ceramic particle or a batch of porous ceramic particles.

Many different aspects and embodiments are possible. Some of these aspects and embodiments are described below. After reading this specification, those skilled in the art will appreciate that these aspects and embodiments are only illustrative and do not limit the scope of the present invention. Embodiments may be in accordance with any one or more of the items as listed below.

### Embodiment 1

A method of forming a batch of porous ceramic particles, wherein the method comprises: preparing an initial batch of ceramic particles having an initial particle size distribution span IPDS equal to (Id₉₀−Id₁₀)/Id₅₀, where Id₉₀ is equal to a d₉₀ particle size distribution measurement of the initial batch of ceramic particles, Id₁₀ is equal to a d₁₀ particle size distribution measurement of the initial batch of ceramic particles and Id₅₀ is equal to a d₅₀ particle size distribution measurement of the initial batch of ceramic particles; and forming the initial batch into a processed batch of porous ceramic particles using a spray fluidization forming process, the processed batch of porous ceramic particles having a processed particle size distribution span PPDS equal to (Pd₉₀−Pd₁₀)/Pd₅₀, where Pd₉₀ is equal to a d₉₀ particle size distribution measurement of the processed batch of porous ceramic particles, Pd₁₀ is equal to the d₁₀ particle size distribution measurement of the processed batch of porous ceramic particles and Pd₅₀ is equal to a d₅₀ particle size distribution measurement of the processed batch of porous ceramic particles; wherein a ratio IPDS/PPDS for the forming of initial batch into the processed batch of porous ceramic particles is at least about 0.90.

### Embodiment 2

The method of embodiment 1, wherein the ratio IPDS/PPDS is at least about 1.10, at least about 1.20, at least about 1.30, at least about 1.40, at east about 1.50, at least about 1.60, at least about 1.70, at least about 1.80, at least about 1.90, at least about 2.00, at least about 2.50, at least about 3.00, at least about 3.50, at least about 4.00, at east about 4.50.

### Embodiment 3

The method of embodiment 1, wherein the IPDS is not greater than about 2.00, not greater than about 0.95, not greater than about 0.90, not greater than about 0.85, not greater than about 0.80, not greater than about 0.75, not greater than about 0.70, not greater than about 0.65, not greater than about 0.60, not greater than about 0.55, not greater than about 0.50, not greater than about 0.45, not greater than about 0.40, not greater than about 0.35, not greater than about 0.30, not greater than about 0.25, not greater than about 0.20, not greater than about 0.15, not greater than about 0.10, not greater than about 0.05.

### Embodiment 4

The method of embodiment 1, wherein the PPDS is not greater than about 2.00, not greater than about 0.95, not greater than about 0.90, not greater than about 0.85, not greater than about 0.80, not greater than about 0.75, not greater than about 0.70, not greater than about 0.65, not greater than about 0.60, not greater than about 0.55, not greater than about 0.50, not greater than about 0.45, not greater than about 0.40, not greater than about 0.35, not greater than about 0.30, not greater than about 0.25, not greater than about 0.20, not greater than about 0.15, not greater than about 0.10, not greater than about 0.05.

### Embodiment 5

The method of embodiment 1, wherein the initial batch of particles comprise an average particle size (Id₅₀) of at least about 100 microns and not greater than about 1500 microns.

### Embodiment 6

The method of embodiment 1, wherein the processed batch of porous ceramic particles comprise an average particle size of at least about 150 microns and not greater than about 4000 microns.

### Embodiment 7

The method of embodiment 1, wherein an average particle size (d₅₀) of the processed batch of porous ceramic particles is at least about 10% greater than an average particle size (d₅₀) of the initial batch of ceramic particles.

### Embodiment 8

The method of embodiment 1, wherein the initial particles comprise a sphericity of at least about 0.8 and not greater than about 0.95.

### Embodiment 9

The method of embodiment 1, wherein the processed particles comprise a sphericity of at least about 0.8 and not greater than about 0.95.

### Embodiment 10

The method of claim 1, wherein the processed particles comprise a porosity of not greater than about 1.60 cc/g and at least about 0.80 cc/g.

### Embodiment 11

The method of embodiment 1, wherein the initial batch of ceramic particles comprises a first finite number of ceramic particles that begin the spray fluidization forming process at the same time.

### Embodiment 12

The method of embodiment 11, wherein the processed batch comprises a second finite number of ceramic particles equal to at least about 80% of the first finite number of ceramic particles that complete the spray fluidization forming process at the same time, at least about 85%, at least about 90%, at least about 91%, at least about 92%, at least about 93%, at least about 94%, at least about 95%, at least about 96%, at least about 97%, at least about 98%, at least about 99%, is equal to the first finite number of ceramic particles.

### Embodiment 13

The method of embodiment 1, wherein the spray fluidization forming process is conducted in a batch mode.

### Embodiment 14

The method of embodiment 13, wherein the batch mode is non-cyclic.

### Embodiment 15

The method of embodiment 13, wherein the batch mode comprises: initiating spray fluidization of the entire initial batch of ceramic particles, spray fluidizing the entire initial batch of ceramic particles to form the entire processed batch of porous ceramic particles, terminating the spray fluidization of the entire processed batch.

### Embodiment 16

The method of embodiment 15, wherein spray fluidization occurs for a predetermined period of time, at least about 5 minutes and not greater than about 600 minutes.

### Embodiment 17

The method of embodiment 15, wherein spray fluidization comprises repeatedly dispensing finely dispersed droplets of a coating fluid onto air borne ceramic particles to form the processed batch of porous ceramic particles.

### Embodiment 18

The method of embodiment 1, wherein the initial batch of ceramic particles comprise alumina, zirconia, titania, silica or a combination thereof.

### Embodiment 19

The method of embodiment 1, wherein the processed batch of porous ceramic particles comprise alumina, zirconia, titania, silica or a combination thereof.

### Embodiment 20

The method of embodiment 1, wherein a cross-section of a ceramic particle from the processed batch of porous ceramic particles comprises a core region and a layered region overlying the core region.

### Embodiment 21

The method of embodiment 20, wherein the core region is monolithic.

### Embodiment 22

The method of embodiment 20, wherein the layered region comprises overlapping layers surrounding the core region.

### Embodiment 23

The method of embodiment 20, wherein the layered region comprises a porosity greater than a porosity of the core region.

### Embodiment 24

The method of embodiment 20, wherein the layered region comprises at least about 10 vol. % of a total volume of the ceramic particle.

### Embodiment 25

The method of embodiment 20, wherein the core region comprises not greater than about 99 vol. % of a total volume of the ceramic particle.

### Embodiment 26

The method of embodiment 20, wherein the core region comprises alumina, zirconia, titania, silica or a combination thereof.

### Embodiment 27

The method of embodiment 20, wherein the layered region comprises alumina, zirconia, titania, silica or a combination thereof.

### Embodiment 28

The method of embodiment 20, wherein the core region and the layered region are the same composition.

### Embodiment 29

The method of embodiment 20, wherein the core region and the layered region are distinct compositions.

### Embodiment 30

The method of embodiment 20, wherein the core region comprises a first alumina phase and the layered region comprises a second alumina phase.

### Embodiment 31

The method of embodiment 30, wherein first alumina phase and the second alumina phase are the same.

### Embodiment 32

The method of embodiment 30, wherein the first alumina phase and the second alumina phase are distinct.

### Embodiment 33

The method of embodiment 30, wherein the first alumina phase is alpha alumina and the second alumina phases is a non-alpha alumina phase.

### Embodiment 34

The method of embodiment 20, wherein an intermediate region exists between the core region and the layered region.

### Embodiment 35

The method of embodiment 1, wherein the method of forming a batch of porous ceramic particles, further comprises sintering the porous ceramic particles at a temperature of at least about 350° C., at least about 375° C., at least about 400° C., at least about 425° C., at least about 450° C., at least about 475° C., at least about 500° C., at least about 525° C., at least about 550° C., at least about 575° C., at least about 600° C., at least about 625° C., at least about 650° C., at least about 675° C., at least about 700° C., at least about 725° C., at least about 750° C., at least about 775° C., at least about 800° C., at least about 825° C., at least about 850° C., at least about 875° C., at least about 900° C., at least about 925° C., at least about 950° C., at least about 975° C., at least about 1000° C., at least about 1100° C., at least about 1200° C., at least about 1400° C.

### Embodiment 36

The method of embodiment 1, wherein the method of forming a batch of porous ceramic particles, further comprises sintering the porous ceramic particles at a temperature of not greater than about 1400° C., not greater than about 1400° C., not greater than about 1200° C., not greater than about 1100° C., not greater than about 1000° C., not greater than about 975° C., not greater than about 950° C., not greater than about 925° C., not greater than about 900° C., not greater than about 875° C., not greater than about 850° C., not greater than about 825° C., not greater than about 800° C., not greater than about 775° C., not greater than about 750° C., not greater than about 725° C., not greater than about 700° C., not greater than about 675° C., not greater than about 650° C., not greater than about 625° C., not greater than about 600° C., not greater than about 575° C., not greater than about 550° C., not greater than about 525° C., not greater than about 500° C., not greater than about 475° C., not greater than about 450° C., not greater than about 425° C., not greater than about 400° C., not greater than about 375° C.

### Embodiment 37

A method of forming a catalyst carrier comprising: forming a porous ceramic particle using a spray fluidization forming process, wherein the porous ceramic particle comprises a particle size of at least about 200 microns and not greater than about 4000 microns; sintering the porous ceramic particle at a temperature of at least about 350° C. not greater than about 1400° C.

### Embodiment 38

The method of embodiment 37, wherein the method of forming a batch of porous ceramic particles, further comprises sintering the porous ceramic particles at a temperature of at least about 350° C., at least about 375° C., at least about 400° C., at least about 425° C., at least about 450° C., at least about 475° C., at least about 500° C., at least about 525° C., at least about 550° C., at least about 575° C., at least about 600° C., at least about 625° C., at least about 650° C., at least about 675° C., at least about 700° C., at least about 725° C., at least about 750° C., at least about 775° C., at least about 800° C., at least about 825° C., at least about 850° C., at least about 875° C., at least about 900° C., at least about 925° C., at least about 950° C., at least about 975° C., at least about 1000° C., at least about 1100° C., at least about 1200° C., at least about 1400° C.

### Embodiment 39

The method of embodiment 37, wherein the method of forming a batch of porous ceramic particles, further comprises sintering the porous ceramic particles at a temperature of not greater than about 1400° C., not greater than about 1400° C., not greater than about 1200° C., not greater than about 1100° C., not greater than about 1000° C., not greater than about 975° C., not greater than about 950° C., not greater than about 925° C., not greater than about 900° C., not greater than about 875° C., not greater than about 850° C., not greater than about 825° C., not greater than about 800° C., not greater than about 775° C., not greater than about 750° C., not greater than about 725° C., not greater than about 700° C., not greater than about 675° C., not greater than about 650° C., not greater than about 625° C., not greater than about 600° C., not greater than about 575° C., not greater than about 550° C., not greater than about 525° C., not greater than about 500° C., not greater than about 475° C., not greater than about 450° C., not greater than about 425° C., not greater than about 400° C., not greater than about 375° C.

### Embodiment 40

The method of embodiment 37, wherein an initial batch of particles used to start the spray fluidization forming process comprises an average particle size (Id₅₀) of at least about 100 microns and not greater than about 1500 microns.

### Embodiment 41

The method of embodiment 37, wherein the processed batch of porous ceramic particles comprise an average particle size of at least about 200 microns and not greater than about 4000 microns.

### Embodiment 42

The method of embodiment 37, wherein the spray fluidization forming process is conducted in a batch mode.

### Embodiment 43

The method of embodiment 42, wherein the batch mode comprises: initiating spray fluidization of the entire initial batch of ceramic particles, spray fluidizing the entire initial batch of ceramic particles to form the entire processed batch of porous ceramic particles, terminating the spray fluidization of the entire processed batch.

### Embodiment 44

The method of embodiment 43, wherein spray fluidization occurs for a predetermined period of time, at least about 10 minutes and not greater than about 600 minutes.

### Embodiment 45

The method of embodiment 43, wherein spray fluidization comprises repeatedly dispensing finely dispersed droplets of a coating fluid onto air borne ceramic particles to form the processed batch of porous ceramic particles.

### Embodiment 46

The method of embodiment 37, wherein the porous ceramic particle comprises a porosity of not greater than about 1.60 cc/g and at least about 0.80 cc/g.

### Embodiment 47

The method of embodiment 37, wherein the porous ceramic particle comprises alumina, zirconia, titania, silica or a combination thereof.

### Embodiment 48

The method of embodiment 37, wherein a cross-section of the porous ceramic particle comprises a core region and a layered region overlying the core region.

### Embodiment 49

The method of embodiment 48, wherein the core region is monolithic.

### Embodiment 50

The method of embodiment 48, wherein the layered region comprises overlapping layers surrounding the core region.

### Embodiment 51

The method of embodiment 48, wherein the core region comprises alumina, zirconia, titania, silica or a combination thereof.

### Embodiment 52

The method of embodiment 48, wherein the layered region comprises alumina, zirconia, titania, silica or a combination thereof.

### Embodiment 53

The method of embodiment 48, wherein the core region and the layered region are the same composition.

### Embodiment 54

The method of embodiment 48, wherein the core region and the layered region are distinct compositions.

### Embodiment 55

The method of embodiment 48, wherein the core region comprises a first alumina phase and the layered region comprises a second alumina phase.

### Embodiment 56

The method of embodiment 55, wherein first alumina phase and the second alumina phase are the same.

### Embodiment 57

The method of embodiment 55, wherein the first alumina phase and the second alumina phase are distinct.

### Embodiment 58

The method of embodiment 55, wherein the first alumina phase is alpha alumina and the second alumina phases is a non-alpha alumina phase.

### Embodiment 59

The method of embodiment 42, wherein the batch mode is non-cyclic.

### Embodiment 60

A method of forming a plurality of porous ceramic particles, wherein the method comprises: forming the plurality of porous ceramic particles using a spray fluidization forming process conducted in a batch mode, wherein the plurality of porous ceramic particle comprise a particle size of at least about 200 microns and not greater than about 4000 microns.

### Embodiment 61

The method of embodiment 60, wherein the batch mode comprises: initiating spray fluidization of an entire initial batch of ceramic particles, spray fluidizing the entire initial batch of ceramic particles to form the entire processed batch of porous ceramic particles, terminating the spray fluidization of the entire processed batch.

### Embodiment 62

The method of embodiment 61, wherein spray fluidization occurs for a predetermined period of time, at least about 10 minutes and not greater than about 600 minutes.

### Embodiment 63

The method of embodiment 61, wherein spray fluidization comprises repeatedly dispensing finely dispersed droplets of a coating fluid onto air borne ceramic particles to form the processed batch of porous ceramic particles.

### Embodiment 64

The method of embodiment 60, wherein the batch mode is non-cyclic.

### Embodiment 65

A porous ceramic particle comprising a particle size of at least about 200 microns and not greater than about 4000 microns, wherein a cross-section of the particle comprises a core region and a layered region overlying the core region.

### Embodiment 66

The porous ceramic particle of embodiment 65, wherein the core region is monolithic.

### Embodiment 67

The porous ceramic particle of embodiment 65, wherein the layered region comprises overlapping layers surrounding the core region.

### Embodiment 68

The porous ceramic particle of embodiment 65, wherein the core region comprises alumina, zirconia, titania, silica or a combination thereof.

### Embodiment 69

The porous ceramic particle of embodiment 65, wherein the layered region comprises alumina, zirconia, titania, silica or a combination thereof.

### Embodiment 70

The porous ceramic particle of embodiment 65, wherein the core region and the layered region are the same composition.

### Embodiment 71

The porous ceramic particle of embodiment 65, wherein the core region and the layered region are distinct compositions.

### Embodiment 72

The porous ceramic particle of embodiment 65, wherein the core region comprises a first alumina phase and the layered region comprises a second alumina phase.

### Embodiment 73

The porous ceramic particle of embodiment 72, wherein first alumina phase and the second alumina phase are the same.

### Embodiment 74

The porous ceramic particle of embodiment 72, wherein the first alumina phase and the second alumina phase are distinct.

### Embodiment 75

The porous ceramic particle of embodiment 72, wherein the first alumina phase is alpha alumina and the second alumina phases is a non-alpha alumina phase.

### Embodiment 76

A plurality of porous ceramic particles comprising: an average porosity of at least about 0.01 cc/g and not greater than about 1.60 cc/g; and an average particle size of at least about 200 microns and not greater than about 4000 microns, wherein the plurality of porous ceramic particles are formed by a spray fluidization forming process operating in a batch mode comprising at least two batch spray fluidization forming cycles.

### Embodiment 77

The plurality of porous ceramic particles of embodiment 76, wherein the at least two batch spray fluidization forming cycles comprises a first cycle and a second cycle, wherein the first cycle comprises: preparing a first initial batch of ceramic particles having an average particle size of at least about 100 microns and not greater than about 4000 microns, and forming the first initial batch into a first processed batch of porous ceramic particles using spray fluidization, wherein the first processed batch of porous ceramic particles has an average particle size (d₅₀) at least about 10% greater than the average particle size (d₅₀) of the first initial batch of ceramic particles; and wherein the second cycle comprises: preparing a second initial batch of ceramic particles from the first processed batch of ceramic particles, and forming the second initial batch into a second processed batch of porous ceramic particles using spray fluidization, wherein the second processed batch of porous ceramic particles has an average particle size (d₅₀) at least about 10% greater than an average particle size (d₅₀) of the second initial batch of ceramic particles.

### Embodiment 78

The plurality of porous ceramic particles of embodiment 77, wherein the first initial batch of ceramic particles has an initial particle size distribution span IPDS equal to (Id₉₀−Id₅₀)/Id₅₀, where Id₉₀ is equal to a d₉₀ particle size distribution measurement of the initial batch of ceramic particles, Id₁₀ is equal to a d₁₀ particle size distribution measurement of the initial batch of ceramic particles and Id₅₀ is equal to a d₅₀ particle size distribution measurement of the initial batch of ceramic particles and the first processed batch of ceramic particles has a processed particle size distribution span PPDS equal to (Pd₉₀−Pd₁₀)/Pd₅₀, where Pd6₉₀ is equal to a d₉₀ particle size distribution measurement of the processed batch of porous ceramic particles, Pd₁₀ is equal to the d₁₀ particle size distribution measurement of the processed batch of porous ceramic particles and Pd₅₀ is equal to a d₅₀ particle size distribution measurement of the processed batch of porous ceramic particles; and wherein the first batch spray fluidization forming cycle has a ratio IPDS/PPDS of at least about 0.90.

### Embodiment 79

The plurality of porous ceramic particles of embodiment 78, wherein the second initial batch of ceramic particles has an initial particle size distribution span IPDS equal to (Id₉₀−Id₁₀)/Id₅₀, where Id₉₀ is equal to a d₉₀ particle size distribution measurement of the initial batch of ceramic particles, Id₁₀ is equal to a d₁₀ particle size distribution measurement of the initial batch of ceramic particles and Id₅₀ is equal to a d₅₀ particle size distribution measurement of the initial batch of ceramic particles and the second processed batch of ceramic particles has a processed particle size distribution span PPDS equal to (Pd₉₀−Pd₁₀)/Pd₅₀, where Pd6₉₀ is equal to a do particle size distribution measurement of the processed batch of porous ceramic particles, Pd₁₀ is equal to the d₁₀ particle size distribution measurement of the processed batch of porous ceramic particles and Pd₅₀ is equal to a d₅₀ particle size distribution measurement of the processed batch of porous ceramic particles; and wherein the second batch spray fluidization forming cycle has a ratio IPDS/PPDS of at least about 0.9.

### Embodiment 80

The plurality of porous ceramic particles of embodiment 76, wherein the process for forming the plurality of porous ceramic particles further comprises sintering the plurality of porous ceramic particles at a temperature of at least about 350° C. and not greater than about 1400° C.

### Embodiment 81

The plurality of porous ceramic particles of embodiment 79, wherein the plurality of porous ceramic particle further comprise a sphericity of at least about 0.80 and not greater than about 0.95.

### Embodiment 82

The plurality of porous ceramic particles of embodiment 79, wherein the ratio IPDS/PPDS is at least about 1.1.

### Embodiment 83

The plurality of porous ceramic particles of embodiment 79, wherein the IPDS is not greater than about 2.00.

### Embodiment 84

The plurality of porous ceramic particles of embodiment 79, wherein the PPDS is not greater than about 2.00.

### Embodiment 85

The plurality of porous ceramic particles of embodiment 86, wherein the core region is monolithic.

### Embodiment 86

The plurality of porous ceramic particles of embodiment 76, wherein the layered region comprises overlapping layers surrounding the core region.

### Embodiment 87

The plurality of porous ceramic particles of embodiment 86, wherein spray fluidization comprises repeatedly dispensing finely dispersed droplets of a coating fluid onto air borne ceramic particles to form the processed batch of porous ceramic particles.

### Embodiment 88

A method of forming a plurality of porous ceramic particles, wherein the method comprises: forming the plurality of porous ceramic particles using a spray fluidization forming process conducted in a batch mode comprising at least two batch spray fluidization forming cycles, wherein the plurality of porous ceramic particles formed by the spray fluidization forming process comprise: an average porosity of at least about 0.01 cc/g and not greater than about 1.60 cc/g, an average particle size of at least about 200 microns and not greater than about 4000 microns.

### Embodiment 89

The method of embodiment 88, wherein the at least two batch spray fluidization cycles comprises a first cycle and a second cycle, wherein the first cycle comprises: preparing a first initial batch of ceramic particles having an average particle size of at least about 100 microns and not greater than about 4000 microns, and forming the first initial batch into a first processed batch of porous ceramic particles using spray fluidization, wherein the first processed batch of porous ceramic particles have an average particle size at least about 10% greater than the average particle size of the first initial batch of ceramic particles; and wherein the second cycle comprises: preparing a second initial batch of ceramic particles from the first processed batch of ceramic particles, and forming the second initial batch into a second processed batch of porous ceramic particles using spray fluidization, wherein the second processed batch of porous ceramic particles have an average particle size at least about 10% greater than an average particle size of the second initial batch of ceramic particles.

### Embodiment 90

The method of embodiment 89, wherein the first initial batch of ceramic particles has an initial particle size distribution span IPDS equal to (Id₉₀−Id₁₀)/Id₅₀, where Id₉₀ is equal to a d₉₀ particle size distribution measurement of the initial batch of ceramic particles, Id₁₀ is equal to a d to particle size distribution measurement of the initial batch of ceramic particles and Id₅₀ is equal to a d₅₀ particle size distribution measurement of the initial batch of ceramic particles and the first processed batch of ceramic particles has a processed particle size distribution span PPDS equal to (Pd₉₀−Pd₁₀)/Pd₅₀, where Pd6₉₀ is equal to a d₉₀ particle size distribution measurement of the processed batch of porous ceramic particles, Pd₁₀ is equal to the d₁₀ particle size distribution measurement of the processed batch of porous ceramic particles and Pd₅₀ is equal to a d₅₀ particle size distribution measurement of the processed batch of porous ceramic particles; and wherein the first batch spray fluidization forming cycle has a ratio IPDS/PPDS of at least about 0.90.

### Embodiment 91

The method of embodiment 90, wherein the second initial batch of ceramic particles has an initial particle size distribution span IPDS equal to (Id₉₀−Id₁₀)/Id₅₀, where Id₉₀ is equal to a d₉₀ particle size distribution measurement of the initial batch of ceramic particles, Id₅₀ is equal to a d₁₀ particle size distribution measurement of the initial batch of ceramic particles and Id₅₀ is equal to a d₅₀ particle size distribution measurement of the initial batch of ceramic particles and the second processed batch of ceramic particles has a processed particle size distribution span PPDS equal to (Pd₉₀−Pd₁₀)/Pd₅₀, where Pd6₉₀ is equal to a d₉₀ particle size distribution measurement of the processed batch of porous ceramic particles, Pd₁₀ is equal to the d₁₀ particle size distribution measurement of the processed batch of porous ceramic particles and Pd₅₀ is equal to a d₅₀ particle size distribution measurement of the processed batch of porous ceramic particles; and wherein the second batch spray fluidization forming cycle has a ratio IPDS/PPDS of at least about 0.90.

### Embodiment 92

The method of embodiment 88, wherein the method further comprises sintering the plurality of porous ceramic particles at a temperature of at least about 350° C. and not greater than about 1400° C.

### Embodiment 93

The method of claim 88, wherein the plurality of porous ceramic particles formed by the spray fluidization forming process further comprise a sphericity of at least about 0.8 and not greater than about 0.95.

### Embodiment 94

The method of embodiment 91, wherein the ratio IPDS/PPDS is at least about 1.10.

### Embodiment 95

The method of embodiment 91, wherein the IPDS is not greater than about 2.00.

### Embodiment 96

The method of embodiment 91, wherein the PPDS is not greater than about 2.00.

### Embodiment 97

The method of embodiment 88, wherein the core region is monolithic.

### Embodiment 98

The method of embodiment 88, wherein the layered region comprises overlapping layers surrounding the core region.

### Embodiment 99

The method of embodiment 88, wherein spray fluidization comprises repeatedly dispensing finely dispersed droplets of a coating fluid onto air borne ceramic particles to form the processed batch of porous ceramic particles.

### Embodiment 100

The plurality of porous ceramic particles of embodiment 76, wherein each ceramic particle of the plurality of porous ceramic particles comprises a cross-sectional structure including a core region and a layered region overlying the core region.

### Embodiment 101

The method of embodiment 88, wherein each ceramic particle of the plurality of porous ceramic particles comprises a cross-sectional structure including a core region and a layered region overlying the core region.

### Embodiment 102

A porous ceramic particle comprising a particle size of at least about 200 microns and not greater than about 4000 microns, wherein a cross-section of the particle comprises a core region and a layered region overlying the core region, wherein the layered region comprises a first layered section surrounding the core region, wherein the core region comprises a core region composition, and wherein the first layered section comprises a first layered section composition different than the core region composition.

### Embodiment 103

The porous ceramic particle of embodiment 102, wherein the core region is monolithic.

### Embodiment 104

The porous ceramic particle of embodiment 102, wherein the core region composition comprises alumina, zirconia, titania, silica or a combination thereof.

### Embodiment 105

The porous ceramic particle of embodiment 102, wherein the first layered section composition comprises alumina, zirconia, titania, silica or a combination thereof.

### Embodiment 106

The porous ceramic particle of embodiment 102, wherein the first layered section comprises an inner surface and an outer surface.

### Embodiment 107

The porous ceramic particle of embodiment 106, wherein the first layered composition of the first layered section comprises a uniform layered section composition throughout a thickness of the first layered section between the inner surface of the first layered section and the outer surface of the first layered section.

### Embodiment 108

The porous ceramic particle of embodiment 106, wherein the first layered composition of the first layered section comprises a gradual concentration gradient composition throughout a thickness of the first layered section between the inner surface of the first layer section and the outer surface of the first layer section, where the gradual concentration gradient is defined as a gradual change from a first concentration of a material in the first layered section composition as measured at the inner surface of the first layered section to a second concentration of the same material in the first layered section composition as measured at the outer surface of the first layered section.

### Embodiment 109

The porous ceramic particle of embodiment 108, wherein the first concentration of the material in the first layered section is less than the second concentration of the same material in the first layered section.

### Embodiment 110

The porous ceramic particle of embodiment 108, wherein the first concentration of the material in the first layered section is greater than the second concentration of the same material in the first layered section.

### Embodiment 111

The porous ceramic particle of embodiment 102, wherein the layered region further comprises a second layered section surrounding the first layered section, and wherein the second layer section comprises a second layered section composition different than the first layered section composition.

### Embodiment 112

The porous ceramic particle of embodiment 111, wherein the second layered section comprises an inner surface and an outer surface.

### Embodiment 113

The porous ceramic particle of embodiment 112, wherein the second layered composition of the second layered section comprises a uniform layered section composition throughout a thickness of the second layered section between the inner surface of the second layered section and the outer surface of the second layered section.

### Embodiment 114

The porous ceramic particle of embodiment 112, wherein the second layered composition of the second layered section comprises a gradual concentration gradient composition throughout a thickness of the second layered section between the inner surface of the second layer section and the outer surface of the second layer section, where the gradual concentration gradient is defined as a gradual change from a first concentration of a material in the second layered section composition as measured at the inner surface of the second layered section to a second concentration of the same material in the second layered section composition as measured at the outer surface of the second layered section.

### Embodiment 115

The porous ceramic particle of embodiment 112, wherein the first concentration of the material in the second layered section is less than the second concentration of the same material in the second layered section.

### Embodiment 116

The porous ceramic particle of embodiment 112, wherein the first concentration of the material in the second layered section is greater than the second concentration of the same material in the second layered section.

### Embodiment 117

A plurality of porous ceramic particles comprising: an average porosity of at least about 0.01 cc/g and not greater than about 1.60 cc/g; and an average particle size of at least about 200 microns and not greater than about 4000 microns, wherein the plurality of porous ceramic particles are formed by a spray fluidization forming process operating in a batch mode comprising a first batch spray fluidization forming cycle, wherein the first batch spray fluidization forming cycle comprises repeatedly dispensing finely dispersed droplets of a first coating fluid onto air borne porous ceramic particles, wherein the ceramic particles comprise a core region composition, wherein the first coating fluid comprises a first coating material composition; and wherein the first coating material composition is different than the core region composition.

### Embodiment 118

A method of forming a batch of porous ceramic particles, wherein the method comprises: preparing an initial batch of ceramic particles having an initial particle size distribution span IPDS equal to (Id₉₀−Id₁₀)/Id₅₀, where Id₉₀ is equal to a d₉₀ particle size distribution measurement of the initial batch of ceramic particles, Id₁₀ is equal to a d₁₀ particle size distribution measurement of the initial batch of ceramic particles and Id₅₀ is equal to a d₅₀ particle size distribution measurement of the initial batch of ceramic particles; and forming the initial batch into a processed batch of porous ceramic particles using a spray fluidization forming process comprising a first batch spray fluidization forming cycle, the processed batch of porous ceramic particles having a processed particle size distribution span PPDS equal to (Pd₉₀−Pd₁₀)/Pd₅₀, where Pd₉₀ is equal to a d₉₀ particle size distribution measurement of the processed batch of porous ceramic particles, Pd₁₀ is equal to the d₁₀ particle size distribution measurement of the processed batch of porous ceramic particles and Pd₅₀ is equal to a d₅₀ particle size distribution measurement of the processed batch of porous ceramic particles, wherein a ratio IPDS/PPDS for the forming of initial batch into the processed batch of porous ceramic particles is at least about 0.90, wherein the first batch spray fluidization forming cycle comprises repeatedly dispensing finely dispersed droplets of a first coating fluid onto air borne porous ceramic particles, wherein the ceramic particles comprise a core region composition, wherein the first coating fluid comprises a first coating material composition; and wherein the first coating material composition is different than the core region composition.

### Embodiment 119

A method of forming a catalyst carrier, wherein the method comprises: forming a porous ceramic particle using a spray fluidization forming process comprising a first batch spray fluidization forming cycle; and sintering the porous ceramic particle at a temperature of at least about 350° C. not greater than about 1400′C, wherein the porous ceramic particle comprises a particle size of at least about 200 microns and not greater than about 4000 microns, wherein the first batch spray fluidization forming cycle comprises repeatedly dispensing finely dispersed droplets of a first coating fluid onto air borne porous ceramic particles, wherein the ceramic particles comprise a core region composition, wherein the first coating fluid comprises a first coating material composition; and wherein the first coating material composition is different than the core region composition.

### Embodiment 120

A method of forming a plurality of porous ceramic particles, wherein the method comprises: forming the plurality of porous ceramic particles using a spray fluidization forming process conducted in a batch mode and comprising at least a first batch spray fluidization forming cycle, wherein the plurality of porous ceramic particle comprise a particle size of at least about 200 microns and not greater than about 4000 microns, wherein the first batch spray fluidization forming cycle comprises repeatedly dispensing finely dispersed droplets of a first coating fluid onto air borne porous ceramic particles, wherein the ceramic particles comprise a core region composition, wherein the first coating fluid comprises a first coating material composition; and wherein the first coating material composition is different than the core region composition.

### Embodiment 121

The plurality of porous ceramic particles or method of any one of embodiments 117, 118, 119, and 120, wherein the core region composition comprises alumina, zirconia, titania, silica or a combination thereof.

### Embodiment 122

The plurality of porous ceramic particles or method of any one of embodiments 117, 118, 119, and 120, wherein the first coating material composition comprises alumina, zirconia, titania, silica or a combination thereof.

### Embodiment 123

The plurality of porous ceramic particles or method of any one of embodiments 117, 118, 119, and 120, wherein the first coating material composition remains constant throughout the first batch spray fluidization forming cycle.

### Embodiment 124

The plurality of porous ceramic particles or method of any one of embodiments 117, 118, 119, and 120, wherein the first coating material composition is changed gradually for a portion of or throughout a duration of the first batch spray fluidization forming cycle by gradually changing the concentration of a material in the first coating material composition from a first concentration of the material at a beginning of the first batch spray fluidization forming cycle to a second concentration of the material at an end of the first batch spray fluidization forming cycle.

### Embodiment 125

The plurality of porous ceramic particles or method of embodiment 124, wherein the first concentration of the material is less than the second concentration of the material.

### Embodiment 126

The porous ceramic particle, plurality of porous ceramic particles or method of embodiment 124, wherein the first concentration of the material is greater than the second concentration of the material.

### Embodiment 127

The plurality of porous ceramic particles or method of any one of embodiments 117, 118, 119, and 120, wherein the spray fluidization forming process further comprises a second batch spray fluidization forming cycle, wherein the second batch spray fluidization forming cycle comprises repeatedly dispensing finely dispersed droplets of a second coating fluid onto air borne ceramic particles formed during the first batch spray fluidization forming cycle to form the processed batch of porous ceramic particles, wherein the second coating fluid comprises a second coating material composition; and wherein the second coating material composition is different than the first coating material composition.

### Embodiment 128

The plurality of porous ceramic particles or method of embodiment 127, wherein the second coating material composition comprises alumina, zirconia, titania, silica or a combination thereof.

### Embodiment 129

The plurality of porous ceramic particles or method of embodiment 128, wherein the second coating material composition remains constant throughout the second batch spray fluidization forming cycle.

### Embodiment 130

The plurality of porous ceramic particles or method of embodiment 128, wherein the second coating material composition is changed gradually for a portion of or throughout a duration of the second batch spray fluidization forming cycle by gradually changing the concentration of a material in the second coating material composition from a first concentration of the material at a beginning of the second batch spray fluidization forming cycle to a second concentration of the material at an end of the second batch spray fluidization forming cycle.

### Embodiment 131

The plurality of porous ceramic particles or method of embodiment 128, wherein the first concentration of the material is less than the second concentration of the material.

### Embodiment 132

The plurality of porous ceramic particles or method of embodiment 128, wherein the first concentration of the material is greater than the second concentration of the material.

### Embodiment 133

A porous ceramic particle comprising a particle size of at least about 200 microns and not greater than about 4000 microns, wherein a cross-section of the particle comprises a core region and a layered region overlying the core region, wherein the layered region comprises a first layered section surrounding the core region, wherein the first layered section comprises an inner surface and an outer surface, wherein the core region comprises a core region composition, wherein the first layered section comprises a first layered section composition different than the core region composition, wherein the first layered composition of the first layered section comprises a gradual concentration gradient composition throughout a thickness of the first layered section between the inner surface of the first layer section and the outer surface of the first layer section.

### EXAMPLES

### Example 1

A four cycle process according to an embodiment described herein was used to form an example batch of ceramic particles that were then formed into a catalyst carrier.

In cycle 1 of the process, seed particles of a Boehmite (alumina) material were used to form a first initial batch of ceramic particles, which had a mass of 800 grams. As measured by the CAMSIZER®, this first initial batch of ceramic particles had a particle size distribution including an Id₁₀=110 μm, an Id₅₀=123 μm, and an Id₉₀=143 μm. The initial particle size distribution span IPDS was equal to 0.27. The first initial batch of ceramic particles was loaded into a VFC-3 spray-fluidizer. These particles were fluidized with an airflow of 38 SCFM (at the beginning of the run) and a temperature of nominally 100° C. This airflow was gradually increased over the course of the run to 50 SCFM. A Boehmite slip was sprayed onto this fluidized bed of particles. The slip consisted of 125 pounds of deionized water, 48.4 pounds of UOP Versal 250 Boehmite alumina, and 1.9 pounds of concentrated nitric acid. The slip had a pH of 4.3, a solids content of 23.4%, and was milled to a median particle size of 4.8 μm. The slip was atomized through a two-fluid nozzle, with an atomization air pressure of 32 psi. A mass of 10,830 grams of slip was applied to the bed of particles over the course of three and one half hours to form a first processed batch of porous ceramic particles. The first processed batch of porous ceramic particles had a mass of 2608 grams and a particle size distribution including a Pd₁₀=168 μm, a Pd₅₀=180 μm and a Pd₉₀=196 μm. The processed particle size distribution span PPDS was equal to 0.16. The ratio IPDS/PPDS for the first cycle of the forming process was equal to 1.7.

In cycle 2 of the process, 2250 grams of the first processed batch of porous ceramic particles (i.e., the product of cycle 1) were used to form a second initial batch of ceramic particles. The second initial batch of ceramic particles had a particle size distribution including an Id₁₀=168 μm, an Id₅₀=180 μm and an Id₉₀=196 μm, and the initial particle size distribution span IPDS was equal to 0.16. These second initial batch of ceramic particles were fluidized with a starting airflow of 45 SCFM, increasing to 58 SCFM by the end of the run, and a temperature of nominally 100° C. A slip of a similar composition as the first cycle was sprayed onto the bed of seeds through the two-fluid nozzle, with an atomization air pressure of 30 psi. A mass of 17,689 grams of slip was applied to the second initial batch of ceramic particles over the course of four and three-quarter hours to form the second processed batch of porous ceramic particles. The second processed batch of porous ceramic particles had a mass of 5796 grams and a particle size distribution includes a Pd₁₀=225 μm, a Pd₅₀=242 μm and a Pd₉₀=262 μm. The processed particle size distribution span PPDS was equal to 0.15. The ratio IPDS/PPDS for the second cycle of the forming process was equal to 1.02.

In cycle 3 of the process, 500 grams of the second processed batch of porous ceramic particles (i.e., the product of cycle 2) were used to form a third initial batch of ceramic particles. The third initial batch of ceramic particles had a particle size distribution including an Id₁₀=225 μm, an Id₅₀=242 μm and an Id₉₀=262 μm, and the initial particle size distribution span IPDS was equal to 0.15. The third initial batch of ceramic particles was fluidized with a starting airflow of 55 SCFM, increasing to 68 SCFM by the end of the run, and a temperature of nominally 100° C. A slip of similar composition as the first cycle is sprayed onto the bed of seeds through the two-fluid nozzle, with an atomization air pressure of 30 psi. A mass of 11,138 grams of slip was applied to the third initial batch of ceramic particles over the course of four and three-quarter hours to form the third processed batch of porous ceramic particles. The third batch of porous ceramic particles had a mass of 2877 grams and a particle size distribution includes a Pd₁₀=430 μm, a Pd₅₀=463 μm and a Pd₉₀=499 μm. The processed particle size distribution span PPDS was equal to 0.15. The ratio IPDS/PPDS for the third cycle of the forming process was equal to 1.03.

In cycle 4 of the process, 2840 grams of third processed batch of porous ceramic particles (i.e., the product of cycle 3) were used to form a fourth initial batch of ceramic particles. The fourth initial batch of ceramic particles had a particle size distribution including an Id₁₀=430 μm, an Id₅₀=463 μm and an Id₉₀=499 μm, and the initial particle size distribution span IPDS was equal to 0.15. The fourth initial batch of ceramic particles was fluidized with a starting airflow of 75 SCFM, increasing to 78 SCFM by the end of the run, and a temperature of nominally 100° C. A slip of similar composition as the first cycle is sprayed onto the bed of seeds through the two-fluid nozzle, with an atomization air pressure of 30 psi. A mass of 3400 grams of slip was applied to the fourth initial batch of ceramic particles over the course thirty minutes to form the fourth processed batch of porous ceramic particles. The fourth batch of porous ceramic particles had a mass of 3581 grams and a particle size distribution that includes a Pd₁₀=466 μm, a Pd₅₀=501 μm and a Pd₅₀=538 μm. The processed particle size distribution span PPDS was equal to 0.14. The ratio IPDS/PPDS for the fourth cycle of the forming process was equal to 1.04.

The fourth batch of porous ceramic particles from cycle 4 was fired in a rotary calciner at 1200° C. forming an alpha alumina (as determined by powder x-ray diffraction) catalyst carrier with a nitrogen BET surface area of 10.0 m2/gram, a mercury intrusion volume of 0.49 cm3/gram. The catalyst carriers had a particle size distribution that includes a D₁₀=377 μm, a D₅₀=409 μm, a D₉₀=447 μm. Further, the catalyst carriers had a distribution span of 0.16, and a CAMSIZER® Shape Analysis Sphericity of 96.0%.

### Example 2

A three cycle process according to an embodiment described herein was used to form an example batch of ceramic particles.

In cycle 1 of the process, seed particles of a Boehmite (alumina) material were used to form a first initial batch of ceramic particles, which had a mass of 2800 grams. As measured by the CAMSIZER®, this first initial batch of ceramic particles had a particle size distribution including an Id₁₀=180 μm, an Id₅₀=197 μm, and an Id₉₀=216 μm. The initial particle size distribution span IPDS was equal to 0.17. The first initial batch of ceramic particles was loaded into a VFC-3 spray-fluidizer. These particles were fluidized with an airflow of 50 SCFM (at the beginning of the run) and a temperature of nominally 100° C. This airflow was gradually increased over the course of the run to 55 SCFM. A Boehmite slip was sprayed onto this fluidized bed of particles. The slip consisted of 175 pounds of deionized water, 72 pounds of UOP Versal 250 Boehmite alumina, and 2.7 pounds of concentrated nitric acid. The slip had a pH of 4.8, a solids content of 23.9%, and is milled to a median particle size of 4.68 μm. The slip was atomized through a two-fluid nozzle, with an atomization air pressure of 35 psi. A mass of 6850 grams of slip was applied to the bed of particles over the course of two hours to form a first processed batch of porous ceramic particles. The first processed batch of porous ceramic particles had a mass of 4248 grams and a particle size distribution including a Pd₁₀=210 μm, a Pd₅₀=227 μm and a Pd₉₀=248 μm. The processed particle size distribution span PPDS was equal to 0.17. The ratio IPDS/PPDS for the first cycle of the forming process was equal to 1.09.

In cycle 2 of the process, 1250 grams of first processed batch of porous ceramic particles (i.e., the product of cycle 1) were used to form a second initial batch of ceramic particles. The second initial batch of ceramic particles had a particle size distribution including an Id₁₀=210 μm, an Id₅₀=227 μm and an Id₉₀=248 μm, and the initial particle size distribution span IPDS was equal to 0.17. The second initial batch of ceramic particles was fluidized with a starting airflow of 55 SCFM, increasing to 67 SCFM by the end of the run, and a temperature of nominally 100° C. A slip of similar composition as the first cycle was sprayed onto the bed of seeds through the two-fluid nozzle, with an atomization air pressure of 35 psi. A mass of 16,350 grams of slip was applied to the second initial batch of ceramic particles over the course of four hours to form the second processed batch of porous ceramic particles. The second processed batch of porous ceramic particles had a mass of 4533 grams and a particle size distribution includes a Pd₁₀=333 μm, a Pd₅₀=356 μm and a Pd₉₀=381 μm. The processed particle size distribution span PPDS was equal to 0.14. The ratio IPDS/PPDS for the second cycle of the forming process was equal to 1.24.

In cycle 3 of the process, 1000 grams of the second processed batch of porous ceramic particles (i.e., the product of cycle 2) were used to form a third initial batch of ceramic particles. The third initial batch of ceramic particles had a particle size distribution including an Id₁₀=333 μm, an Id₅₀=356 μm and an Id₉₀=381 μm, and the initial particle size distribution span IPDS was equal to 0.14. The third initial batch of ceramic particles was fluidized with a starting airflow of 75 SCFM, increasing to 89 SCFM by the end of the run, and a temperature of nominally 100° C. A slip of similar composition as the first cycle is sprayed onto the bed of seeds through the two-fluid nozzle, with an atomization air pressure of 35 psi. A mass of 13,000 grams of slip was applied to the third initial batch of ceramic particles over the course of two and a third hours to form the third processed batch of porous ceramic particles. The third processed batch of porous ceramic particles had a mass of 4003 grams and a particle size distribution includes a Pd₁₀=530 μm, a Pd₅₀=562 μm and a Pd₉₀=596 μm. The processed particle size distribution span PPDS was equal to 0.12. The ratio IPDS/PPDS for the third cycle of the forming process was equal to 1.15.

### Example 3

Three alternate two cycle processes having the same first cycle and according to an embodiment described herein were used to form example batches or ceramic particles that were then formed into catalyst carriers.

In cycle 1 of the process, seed particles of an amorphous silica material were used to form a first initial batch of ceramic particles, which had a mass of 950 grams. As measured by the CAMSIZER®, this first initial batch of ceramic particles had a particle size distribution including an Id₁₀=188 μm, an Id₅₀=209 μm, and an Id₉₀=235 μm. The initial particle size distribution span IPDS was equal to 0.23. The first initial batch of ceramic particles was loaded into a VFC-3 spray-fluidizer. These particles were fluidized with an airflow of 35 SCFM (at the beginning of the run) and a temperature of nominally 100° C. This airflow was gradually increased over the course of the run to 43 SCFM. A slip was sprayed onto this fluidized bed of particles. The slip consisted of 62 pounds of deionized water, 13.5 pounds of Grace-Davison C805 synthetic amorphous silica gel, 5.6 pounds of Nalco 1142 colloidal silica, 0.53 pounds of sodium hydroxide, and 1.3 pounds of DuPont Elvanol 51-05 polyvinyl alcohol. The slip had a pH of 10.1, a solids content of 21.8%, and was milled to a median particle size of 4.48 μm. The slip was atomized through a two-fluid nozzle, with an atomization air pressure of 30 psi. A mass of 7425 grams of slip was applied to the bed of particles over the course of two hours to form a first processed batch of porous ceramic particles. The first processed batch of porous ceramic particles had a mass of 2124 grams and a particle size distribution including a Pd₁₀=254 μm, a Pd₅₀=276 μm and a Pd₉₀=301 μm. The processed particle size distribution span PPDS was equal to 0.17. The ratio IPDS/PPDS for the first cycle of the forming process was equal to 1.32.

In a first cycle 2 iteration of the process, 2,500 grams of the first processed batch of porous ceramic particles (i.e., the product of cycle 1) were used to form a second initial batch of ceramic particles. The second initial batch of ceramic particles had a particle size distribution including an Id₁₀=254 μm, an Id₅₀=276 μm and an Id₉₀=301 μm, and the initial particle size distribution span IPDS was equal to 0.17. The second initial batch of ceramic particles were fluidized with a starting airflow of 43 SCFM and increased to 46 SCFM by the end of the run at a temperature of nominally 100° C. A slip of similar composition as the first cycle was sprayed onto the bed of seeds through the two-fluid nozzle, with an atomization air pressure of 30 psi. A mass of 14,834 grams of slip was applied to the second initial batch of ceramic particles over the course of three and one quarter hours to form the second processed batch of porous ceramic particles. The second processed batch of porous ceramic particles had a mass of 2849 grams and a particle size distribution includes a Pd₁₀=476 μm, a Pd₅₀=508 μm and a Pd₉₀=543 μm. The processed particle size distribution span PPDS was equal to 0.13. The ratio IPDS/PPDS for the second cycle of the forming process was equal to 1.29.

In a second cycle 2 iteration of the process, 2,500 grams of the first processed batch of porous ceramic particles (i.e., the product of cycle 1) were used to form a second initial batch of ceramic particles. The second initial batch of ceramic particles had a particle size distribution including an Id₁₀=254 μm, an Id₅₀=276 μm and an Id₉₀=301 μm, and the initial particle size distribution span IPDS was equal to 0.17. The second initial batch of ceramic particles were fluidized with a starting airflow of 43 SCFM and increased to 47 SCFM by the end of the run at a temperature that starts at 92° C. and increases to 147° C. by the end of the run. A slip of similar composition as the first cycle, but with a solids content of 19.7%, was sprayed onto the bed of seeds through the two-fluid nozzle, with an atomization air pressure of 35 psi. A mass of 16,931 grams of slip was applied to the second initial batch of ceramic particles over the course of three and one quarter hours to form the second processed batch of porous ceramic particles. The second processed batch of porous ceramic particles had a mass of 3384 grams and a particle size distribution includes a Pd₁₀=482 μm, a Pd₅₀=511 μm and a Pd₉₀=543 μm. The processed particle size distribution span PPDS was equal to 0.12. The ratio IPDS/PPDS for the second cycle of the forming process was equal to 1.43.

In a third cycle 2 iteration of the process, 2,500 grams of the first processed batch of porous ceramic particles (i.e., the product of cycle 1) were used to form a second initial batch of ceramic particles. The second initial batch of ceramic particles had a particle size distribution including an Id₁₀=254 μm, an Id₅₀=276 μm and an Id₉₀=301 μm, and the initial particle size distribution span IPDS was equal to 0.17. The second initial batch of ceramic particles were fluidized with a starting airflow of 43 SCFM and increased to 48 SCFM by the end of the run at a temperature that starts at 92° C. and increases to 147° C. by the end of the run. A slip of similar composition as the first cycle, but with a solids content of 20.9%, was sprayed onto the bed of seeds through the two-fluid nozzle, with an atomization air pressure of 35 psi. A mass of 16,938 grams of slip was applied to the second initial batch of ceramic particles over the course of three and one quarter hours to form the second processed batch of porous ceramic particles. The second processed batch of porous ceramic particles had a mass of 3412 grams and a particle size distribution includes a Pd₁₀=481 μm, a Pd₅₀=512 μm and a Pd₉₀=544 μm. The processed particle size distribution span PPDS was equal to 0.12. The ratio IPDS/PPDS for the second cycle of the forming process was equal to 1.38.

The greenware product from the three cycle 2 iterations were combined and fired in a rotary calciner at 650° C. This produced an amorphous silica (as determined by powder x-ray diffraction) catalyst carrier with a nitrogen BET surface area of 196 m²/gram, a mercury absorption pore volume of 1.34 cm³/gram, and a particle size distribution of D₁₀=468 μm, a D₅₀=499 μm, a D₉₀=531 μm, a span of 0.13, and a CAMSIZER® Shape Analysis Sphericity of 96.3%.

### Example 4

A three cycle process according to an embodiment described herein was used to form an example batch of ceramic particles.

In cycle 1 of the process, seed particles of a Zirconia material were used to form a first initial batch of ceramic particles, which had a mass of 247 grams. As measured by the CAMSIZER®, this first initial batch of ceramic particles had a particle size distribution including an Id₁₀=110 μm, an Id₅₀=135 μm, and an Id₉₀=170 μm. The initial particle size distribution span IPDS was equal to 0.44. The first initial batch of ceramic particles was loaded into a VFC-3 spray-fluidizer. These particles were fluidized with an airflow that starts at 34 SCFM and increases to 40 SCFM by the end of the run, with a temperature that starts at 93° C. and increases to 130° C. by the end of the run. A slip consisting of a mixture of 29 pounds of deionized water, 7.5 pounds of Daiichi Kigenso Kagaku Kogyo RC-100 Zirconia powder, 0.3 pounds of concentrated nitric acid, 0.3 pounds of Sigma Aldrich polyethyleneimine, and 0.22 pounds of DuPont Elvanol 51-05 polyvinyl alcohol is prepared. The slip has a pH of 3.1, a solids content of 20.4%, and a median particle size of 2.92 μm. The slip was atomized through a two-fluid nozzle, with an atomization air pressure of 35 psi. A mass of 3487 grams of slip was applied to the bed of particles over the course of 1 hour to form a first processed batch of porous ceramic particles. The first processed batch of porous ceramic particles had a mass of 406 grams and a particle size distribution including a Pd₁₀=141 μm, a Pd₅₀=165 μm and a Pd₉₀=185 μm. The processed particle size distribution span PPDS was equal to 0.27. The ratio IPDS/PPDS for the first cycle of the forming process was equal to 1.67.

In cycle 2 of the process, 400 grams of first processed batch of porous ceramic particles (i.e., the product of cycle 1) were used to form a second initial batch of ceramic particles. The second initial batch of ceramic particles had a particle size distribution including an Id₁₀=141 μm, an Id₅₀=165 μm and an Id₉₀=185 μm, and the initial particle size distribution span IPDS was equal to 0.27. The second initial batch of ceramic particles was fluidized with a starting airflow of 40 SCFM, increasing to 44 SCFM by the end of the run, and a temperature of nominally 130° C. A slip of similar composition as the first cycle was sprayed onto the bed of seeds through the two-fluid nozzle, with an atomization air pressure of 35 psi. A mass of 3410 grams of slip was applied to the second initial batch of ceramic particles over the course of 1 hour to form the second processed batch of porous ceramic particles. The second processed batch of porous ceramic particles had a mass of 644 grams and a particle size distribution includes a Pd₁₀=172 μm, a Pd₅₀=191 μm and a Pd₉₀=213 μm. The processed particle size distribution span PPDS was equal to 0.22. The ratio IPDS/PPDS for the second cycle of the forming process was equal to 1.24.

In cycle 3 of the process, 500 grams of the second processed batch of porous ceramic particles (i.e., the product of cycle 2) were used to form a third initial batch of ceramic particles. The third initial batch of ceramic particles had a particle size distribution including an Id₁₀=172 μm, an Id₅₀=191 μm and an Id₉₀=213 μm, and the initial particle size distribution span IPDS was equal to 0.22. The third initial batch of ceramic particles was fluidized with a starting airflow of 45 SCFM, increasing to 44 SCFM by the end of the run, and a temperature of nominally 130° C. A slip of similar composition as the first cycle is sprayed onto the bed of seeds through the two-fluid nozzle, with an atomization air pressure of 35 psi. A mass of 4,554 grams of slip was applied to the third initial batch of ceramic particles over the course of one hour to form the third processed batch of porous ceramic particles. The third processed batch of porous ceramic particles had a mass of 893 grams and a particle size distribution includes a Pd₁₀=212 μm, a Pd₅₀=231 μm and a Pd₉₀=249 μm. The processed particle size distribution span PPDS was equal to 0.16. The ratio IPDS/PPDS for the third cycle of the forming process was equal to 1.34.

### Example 5

A two cycle process according to an embodiment described herein was used to form an example batch of ceramic particles that were then formed into a catalyst carrier.

In cycle 1 of the process, seed particles of a Boehmite (alumina) material were used to form a first initial batch of ceramic particles, which had a mass of 1000 grams. As measured by the CAMSIZER®, this first initial batch of ceramic particles had a particle size distribution including an Id₁₀=480 μm, an Id₅₀=517 μm, and an Id₉₀=549 μm. The initial particle size distribution span IPDS was equal to 0.119. The first initial batch of ceramic particles was loaded into a VFC-3 spray-fluidizer. These particles were fluidized with an airflow of 85 Standard Cubic Feet Per Minute (SCFM) (which is equivalent to 2405 lpm) at the beginning of the run and a temperature of nominally 100° C. A Boehmite slip was sprayed onto this fluidized bed of particles. The slip consisted of 6350 g of deionized water, 2288 g of UOP Versal 250 Boehmite alumina, 254 g of Sasol Catapal B Boehmite alumina, and 104 g of concentrated nitric acid. The slip had a pH of 4.3, a solids content of 26.5%, and was milled to a median particle size of 4.8 μm. The slip was atomized through a two-fluid nozzle, with an atomization air pressure of 40 psi. Under stirring, to the slip was continually added 1000 g of MEL, Inc. Zirconium Acetate solution, with 36.42% solid content. The starting zirconia concentration of the slip was 0% and the zirconia concentration was increased to 10.5% by the end of the process. A mass of 7024 grams of Boehmite slip, as well as 1000 g of Zirconium Acetate solution was applied to the bed of particles over the course of one and one half hours to form a first processed batch of porous ceramic particles. The first processed batch of porous ceramic particles had a mass of 2943 grams and a particle size distribution including a Pd₁₀=679 μm, a Pd₅₀=733 μm and a Pd₉₀=778 μm. The processed particle size distribution span PPDS was equal to 0.135.

In cycle 2 of the process, 1000 grams of the first processed batch of porous ceramic particles (i.e., the product of cycle 1) were used to form a second initial batch of ceramic particles. The second initial batch of ceramic particles had a particle size distribution including an Id₁₀=679 μm, an Id₅₀=733 μm and an Id₉₀=778 μm, and the initial particle size distribution span IPDS was equal to 0.135. These second initial batch of ceramic particles were fluidized with a starting airflow of 95 SCFM (2689 lpm), increasing to 100 SCFM (2830 lpm) by the end of the run, and a temperature of nominally 100° C. A second slip, consisting of 5675 g of deionized water, 1944 g of UOP Versal 250 Boehmite alumina, 169 g of Sasol Catapal B Boehmite alumina, 104 g of concentrated nitric acid, and 950 g of Zirconium Acetate solution was prepared. The zirconia content of the second slip was 10.5% on an oxide basis. The slip had a pH of 4.9, a solids content of 26.2%, and was milled to a median particle size of 4.8 μm To this slip was added continually while stirring, 1168 g of Zirconium Acetate solution, which was sprayed onto the bed of seeds through the two-fluid nozzle, with an atomization air pressure of 40 psi. The starting zirconia concentration of the slip was 10.5% and the zirconia concentration was increased to 20% by the end of the process. A mass of 7686 grams of Boehmite slip as well as the 1168 g of Zirconium Acetate solution was applied to the second initial batch of ceramic particles over the course of one and one-half hours to form the second processed batch of porous ceramic particles. The second processed batch of porous ceramic particles had a mass of 3203 grams and a particle size distribution including a Pd₁₀=990 μm, a Pd₅₀=1030 μm and a Pd₉₀=1079 μm. The processed particle size distribution span PPDS was equal to 0.087.

The second batch of porous ceramic particles from cycle 2 was fired in a muffle furnace at 1000° C. forming a gamma alumina and tetragonal zirconia (as determined by powder x-ray diffraction) catalyst carrier with a nitrogen BET surface area of 113 m²/gram, a mercury intrusion volume of 0.40 cm³/gram. The catalyst carriers had a particle size distribution that includes a D₁₀=891 μm, a D₅₀=941 μm, a D₉₀=991 μm. Further, the catalyst carriers had a distribution span of 0.106, and a CAMSIZER® Shape Analysis Sphericity of 96.1%. Further, the catalyst carriers were comprised of 82.3% Al₂O₃, 17.0% ZrO₂, 0.4% HfO₂, and 0.2% SiO₂ as measured by XRF.

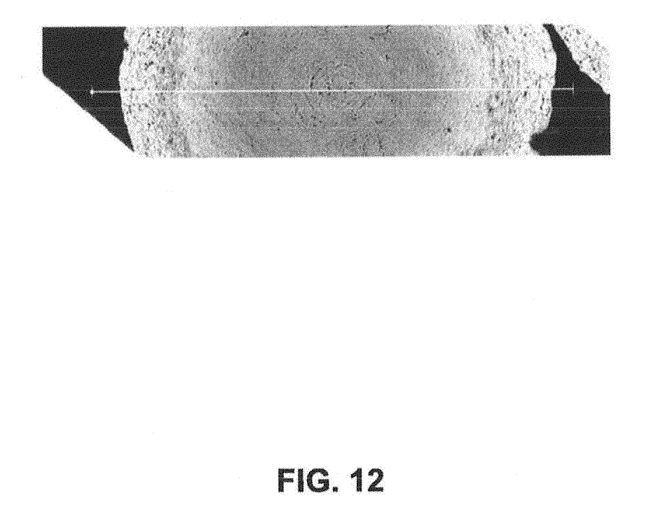

FIG. 12 includes an image of a microstructure of a catalyst carrier formed through the process of Example 5.

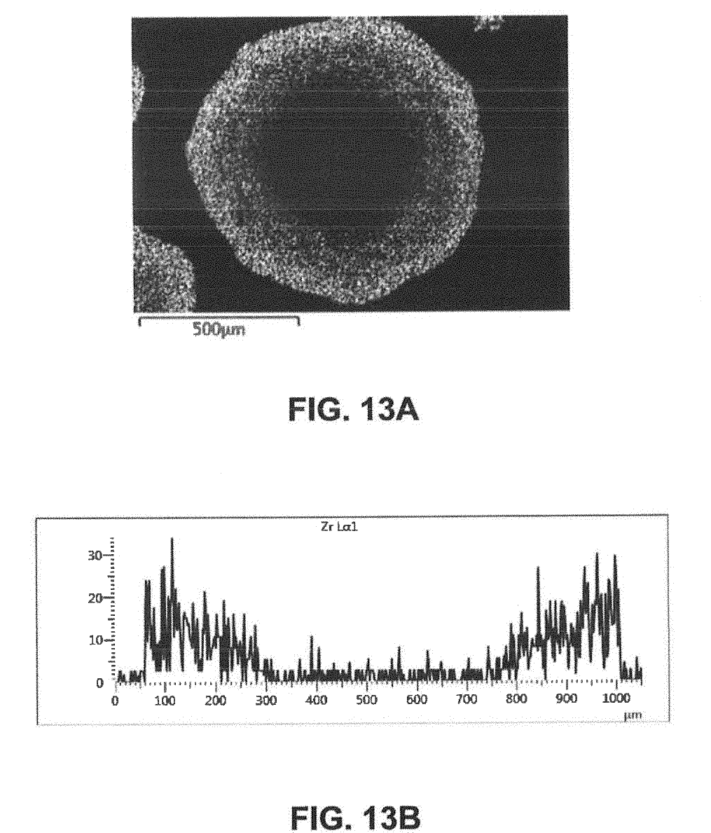

FIG. 13A includes an energy-dispersive X-ray spectroscopic image of the catalyst carrier showing the concentration of zirconia throughout a cross-sectional image of the catalyst carrier formed through the process of Example 5. FIG. 13B includes a plot showing the concentration of zirconia relative to the location within the cross-sectional image of the catalyst carrier. As shown in FIGS. 13A and 13B, the concentration gradient of zirconia increased moving from the center of the cross-sectional image of the catalyst carrier to the outer perimeter of the cross-sectional image of the catalyst carrier.

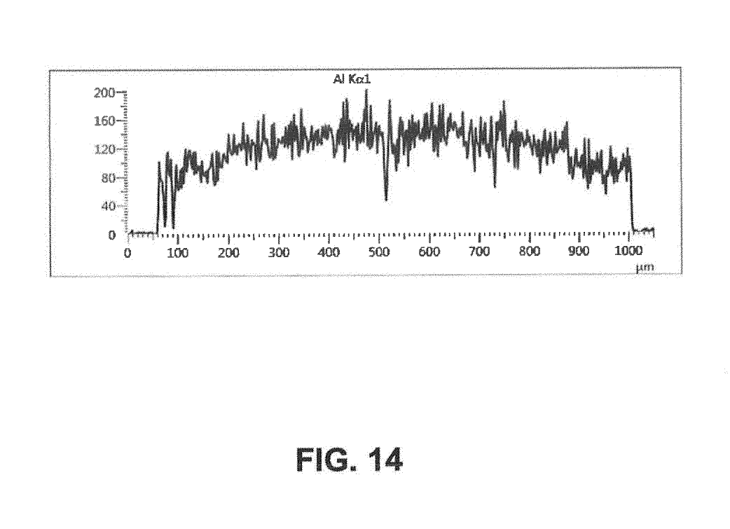

FIG. 14 includes a plot showing the concentration of alumina relative to the location within the cross-sectional image of the catalyst carrier. As shown in FIG. 14, the concentration gradient of alumina decreased moving from the center of the cross-sectional image of the catalyst carrier to the outer perimeter of the cross-sectional image of the catalyst carrier.

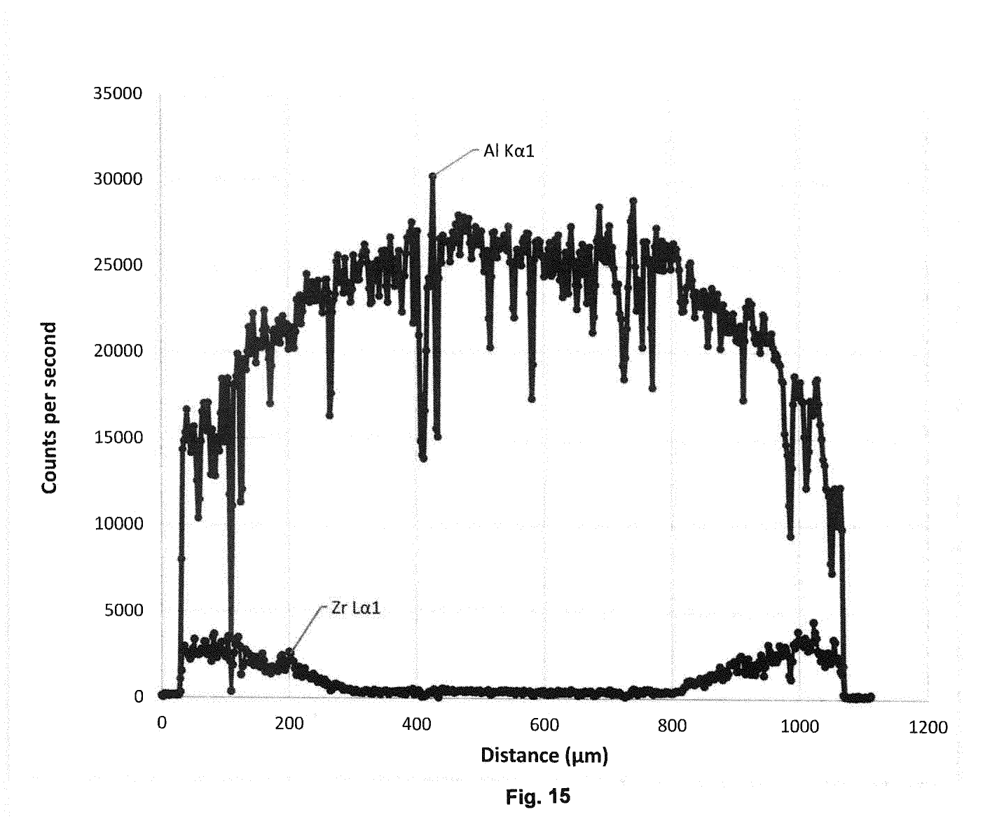

FIG. 15 includes a plot showing both the concentration of zirconia and the concentration of alumina relative to the location within the cross-sectional image of a catalyst carrier formed according to embodiments described herein. As shown in FIG. 15, the concentration gradient of zirconia increased moving from the center of the cross-sectional image of the catalyst carrier to the outer perimeter of the cross-sectional image of the catalyst carrier and the concentration gradient of alumina decreased moving from the center of the cross-sectional image of the catalyst carrier to the outer perimeter of the cross-sectional image of the catalyst carrier.

In the foregoing, it will be appreciated that the sphericity of the porous ceramic particles or catalyst carriers shown in the images of the figures is not necessarily indicative of the actual sphericity of these particles or catalyst carriers. It will be further appreciated that the sphericity of the porous ceramic particles or catalyst carriers shown in the images of the figures may be any sphericity described in reference to embodiments described herein, for example, the sphericity of the porous ceramic particles or catalyst carriers shown in the images of the figures may be within a range of at least about 0.80 and not greater than about 0.99.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. A porous ceramic particle comprising a particle size of at least about 200 microns and not greater than about 4000 microns, wherein a cross-section of the particle comprises a core region and a layered region overlying the core region,
wherein the layered region comprises a first layered section surrounding the core region,
wherein the core region comprises a core region composition, and
wherein the first layered section comprises a first layered section composition different than the core region composition.

2. The porous ceramic particle of claim 1, wherein the core region is monolithic.

3. The porous ceramic particle of claim 1, wherein the core region composition comprises alumina, zirconia, titania, silica or a combination thereof.

4. The porous ceramic particle of claim 1, wherein the first layered section composition comprises alumina, zirconia, titania, silica or a combination thereof.

5. The porous ceramic particle of claim 1, wherein the first layered section comprises an inner surface and an outer surface.

6. The porous ceramic particle of claim 5, wherein the first layered composition of the first layered section comprises a uniform layered section composition throughout a thickness of the first layered section between the inner surface of the first layered section and the outer surface of the first layered section.

7. The porous ceramic particle of claim 5, wherein the first layered composition of the first layered section comprises a gradual concentration gradient composition throughout a thickness of the first layered section between the inner surface of the first layer section and the outer surface of the first layer section, where the gradual concentration gradient is defined as a gradual change from a first concentration of a material in the first layered section composition as measured at the inner surface of the first layered section to a second concentration of the same material in the first layered section composition as measured at the outer surface of the first layered section.

8. The porous ceramic particle of claim 7, wherein the first concentration of the material in the first layered section is less than the second concentration of the same material in the first layered section.

9. The porous ceramic particle of claim 7, wherein the first concentration of the material in the first layered section is greater than the second concentration of the same material in the first layered section.

10. The porous ceramic particle of claim 1, wherein the layered region further comprises a second layered section surrounding the first layered section, and wherein the second layer section comprises a second layered section composition different than the first layered section composition.

11. The porous ceramic particle of claim 10, wherein the second layered section comprises an inner surface and an outer surface.

12. The porous ceramic particle of claim 11, wherein the second layered composition of the second layered section comprises a uniform layered section composition throughout a thickness of the second layered section between the inner surface of the second layered section and the outer surface of the second layered section.

13. The porous ceramic particle of claim 11, wherein the second layered composition of the second layered section comprises a gradual concentration gradient composition throughout a thickness of the second layered section between the inner surface of the second layer section and the outer surface of the second layer section, where the gradual concentration gradient is defined as a gradual change from a first concentration of a material in the second layered section composition as measured at the inner surface of the second layered section to a second concentration of the same material in the second layered section composition as measured at the outer surface of the second layered section.

14. The porous ceramic particle of claim 11, wherein the first concentration of the material in the second layered section is less than the second concentration of the same material in the second layered section.

15. The porous ceramic particle of claim 11, wherein the first concentration of the material in the second layered section is greater than the second concentration of the same material in the second layered section.

16. A plurality of porous ceramic particles comprising:
an average porosity of at least about 0.01 cc/g and not greater than about 1.60 cc/g; and
an average particle size of at least about 200 microns and not greater than about 4000 microns,
wherein the plurality of porous ceramic particles are formed by a spray fluidization forming process operating in a batch mode comprising a first batch spray fluidization forming cycle,
wherein the first batch spray fluidization forming cycle comprises repeatedly dispensing finely dispersed droplets of a first coating fluid onto air borne porous ceramic particles,
wherein the ceramic particles comprise a core region composition,
wherein the first coating fluid comprises a first coating material composition; and
wherein the first coating material composition is different than the core region composition.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A porous ceramic particle comprising a particle size of at least about 200 microns and not greater than about 4000 microns, wherein a cross-section of the particle comprises a core region and a layered region overlying the core region,
wherein the layered region comprises a first layered section surrounding the core region,
wherein the first layered section comprises an inner surface and an outer surface,
wherein the core region comprises a core region composition,
wherein the first layered section comprises a first layered section composition different than the core region composition,
wherein the first layered composition of the first layered section comprises a gradual concentration gradient composition throughout a thickness of the first layered section between the inner surface of the first layer section and the outer surface of the first layer section.
